(19) United States
(12) Patent Application Publication
(10) Pub. No.: US 2016/0085346 A1
(43) Pub. Date: Mar. 24, 2016

(54) TOUCH PANEL MODULE AND ELECTRONIC INFORMATION EQUIPMENT

(71) Applicant: SHARP KABUSHIKI KAISHA, Osaka (JP)

(72) Inventors: Hiroaki TSUKAMOTO, Osaka-shi, Osaka (JP); Nakae NAKAMURA, Osaka-shi, Osaka (JP); Nobuaki ASAYAMA, Osaka-shi, Osaka (JP)

(73) Assignee: Sharp Kabushiki Kaisha, Osaka-shi, Osaka (JP)

(21) Appl. No.: 14/785,082

(22) PCT Filed: Apr. 7, 2014
(86) PCT No.: PCT/JP2014/001995

§ 371 Date: Oct. 16, 2015

(30) Foreign Application Priority Data
Apr. 18, 2013 (JP) 2013-087490

(51) Int. Cl. G06F 3/047; G06F 3/044; G06F 3/041

(52) U.S. Cl. CPC G06F 3/047; G06F 3/0416; G06F 3/044

(57) ABSTRACT

In a touch panel module, speed up of reaction speed for an input operation, lower current consumption, and suppression of generation of heat in a sensor electrode are enhanced by attaining lower resistance of the sensor electrode. A touch panel module 100 comprises a sensor section 110 for detecting an input operation, and peripheral wiring sections 120a and 120b disposed at the periphery of the sensor section, wherein: a sensor section substrate 111 constituting the sensor section and a peripheral wiring section substrate 121 constituting the peripheral wiring sections are separate substrates; a plurality of sensor section wirings 112a and 112b included in the sensor section are formed with a metal film having lower resistance compared to a conductive film constituting a plurality of peripheral wirings 122a and 122b of the peripheral wiring section; and peripheral wirings are formed with a transparent conductive film having a smaller minimum processing pattern width and a smaller minimum processing pattern pitch compared to the metal film constituting the sensor section wirings.

### TECHNICAL FIELD

The present invention relates to a touch panel module and electronic information equipment, and specifically relates to a touch panel module enabling multi-touch that is used in personal computers (PC), tablet terminals or the like, and electronic information equipment equipped with such a touch panel module.

### BACKGROUND ART

In recent years, a touch panel used in combination with a display device (display) is installed as an input device in electronic information equipment such as a computer or a mobile terminal.

There are various forms of touch panels, such as the resistive film type, surface acoustic wave type, and infrared type touch panels. In capacitive touch panels enabling multi-touch that are used in PC terminals and tablet terminals, there are touch panels used for displays in various sizes ranging from a small type display to a large type display.

Such capacitive touch panels have a plurality of electrodes arranged on an input operation surface (hereinafter, also simply referred to as an operation surface), and are configured to detect a change in capacitance in accordance with a touch operation or a proximity operation, with a finger of an operator between adjacent electrodes, as the input operation.

In the above-mentioned electronic information equipment such as a PC terminal or a tablet terminal, a touch panel substrate made by forming such electrodes on an insulation substrate is installed as a touch panel module together with a control substrate equipped with a control circuit and the like. Herein, the touch panel module is a part that realizes a basic function in a touch panel, that is, a function of detecting the position of an input operation.

FIG. 20 is a diagram for explaining a conventional touch panel module which shows the overall structure of this touch panel module.

This touch panel module 5 comprises a sensor section 50 that detects an input operation, and first and second peripheral wiring sections 70a and 70b that are disposed at the periphery of this sensor section 50. Herein, the sensor section 50 comprises a first sensor section 50a made by forming a plurality of first sensor section wirings 52a on a first insulation sheet (sensor sheet) 51a, and a second sensor section 50b made by forming a plurality of second sensor section wirings 52b on a second insulation sheet (sensor sheet) 51b.

Herein, the first sensor section wirings 52a have first sensor electrodes 53a extending along a first direction K (horizontal, direction) on the first insulation sheet 51a, and first electrode drawing wires 54a which draw the first sensor electrodes 53a to the peripheral edge of the first insulation sheet 51a. In addition, the second sensor section wirings 52b have second sensor electrodes 53b extending along a second direction Y (vertical direction) on the second insulation sheet 51b, and second electrode drawing wires 54b which draw the second sensor electrodes 53b to the peripheral edge of the second insulation sheet 51b. Further, the first electrode drawing wires 54a are disposed at a portion R50a positioned at one side of the disposition region of the first sensor electrodes 53a on the first insulation sheet 51a, and one end of each of the first electrode drawing wires 54a are connected to one end of each of the corresponding first sensor electrodes 53a. The second electrode drawing wires 54b are disposed at a portion R50b positioned at one side of the disposition region of the second sensor electrodes 53b on the second insulation sheet 51b, and one end of each of the second electrode drawing wires 54b are connected to one end of each of the corresponding second sensor electrodes 53b.

The first sensor electrodes 53a and the first electrode drawing wires 54a are formed on the first insulation sheet 51a by a patterning of an ITO (indium tin oxide) film, and the second sensor electrodes 53b and the second electrode drawing wires 54b are formed on the second insulation sheet 51b by a patterning of an ITO (indium tin oxide) film. The first and second insulation sheets 51a and 51b are adhered such that the first sensor electrodes 53a and the second sensor electrodes 53b are orthogonal and are insulated from each other to constitute one sensor section substrate 51. This sensor section substrate 51 is adhered to a glass substrate 60, and is supported by this glass substrate 60.

A peripheral wiring section 70a base structure made by forming a plurality of first peripheral wirings 72a on a first flexible print substrate 71a, and one end of each of the plurality of peripheral wirings 72a is joined to one end of the corresponding electrode drawing wire 54a, thereby fixing the first flexible print substrate 71a to the sensor section substrate 51. A peripheral wiring section 70b has a structure made by forming a plurality of second peripheral wirings 72b on a second flexible print substrate 71b, and one end of each of the plurality of peripheral wirings 72b is joined to one end of the corresponding second electrode drawing wire 54b, thereby fixing the second flexible print substrate 71b to the sensor section substrate 51. Herein, the first and second peripheral wirings 72a and 72b are formed on the first and second flexible print substrates 71a and 71b, respectively, by a patterning of an ITO (iridium tin oxide) film.

In addition, these flexible substrates 71a and 71b are installed with a substrate module 80 having a structure in which an insulation substrate 80a is equipped with each IC chip as a driver IC 81, a controller IC 82 and a power source IC 83. Herein, for example, the drover IC 81 is configured to drive the first and second sensor electrodes 53a and 53b; the controller IC 82 is configured to control the driver IC 81; and the power source IC 83 is configured to generate a voltage required for driving the sensor electrodes, and a voltage required as the power source of the driver IC 81 and the controller IC 82.

The touch panel module 5 having such a configuration is used as an input device in electronic information equipment such as a computer or a mobile terminal, in combination with a display device (display).

Next, the operation will be briefly explained.

For example, when the power source IC 83 of the substrate module 80 generates a driving voltage, the driver IC 81 drives the first and second sensor electrodes 53a and 53h under the control of the controller IC 82. If an operator performs an input operation such as a touch operation in which the sensor section 50 of the touch panel module 5 is touched by a finger, or a proximity operation in which a finger is approximated, the capacity at the intersecting sections of the first sensor electrodes 53a and the second sensor electrodes 53b changes at the portion of the sensor section 50 on which an input operation is performed, and the position where this capacitance change is caused is computed by the controller IC 83. In this manner, based on an operation menu displayed on the display device, processing in accordance with the position of an input operation is performed in the electronic information equipment.

Further, Patent Literature 1 discloses a lattice touch sensing system as a capacitive touch panel as in the above.

### CITATION LIST

### Patent Literature

Patent Literature 1: Japanese Laid-Open Publication No. 2006-511879

### SUMMARY OF INVENTION

### Technical Problem

Meanwhile, as touch panels become larger in size, reaction speed of an electrode (sensor electrode) as a sensor for detecting an input operation, that is, change speed of capacitance among sensor electrodes is becoming important, and importance of low power consumption has also been increasing.

However, the sensor section wirings 52a and 52b forming the sensor section 50 are made of an ITO (indium tin oxide) that is transparent and conductive, and a conductor resistance value of a sensor section wiring consisting of this ITO film becomes higher in large size touch panels. As a result, there was a problem that speed of response to an input operation becomes slow, that is, detection of an operation position requires time, and also current consumption becomes higher and equipment at the periphery of the touch panel module is influenced by generation of heat at the sensor section.

Specifically, when reaction speed of a sensor electrode becomes slow, even if an input operation of a picture, a letter or the like is performed on a touch panel, response such as display for this input operation is delayed. Further, the conductor resistance of a sensor electrode being high means that there is a large current consumption in a touch panel, and thus in relation to charging time of a laptop mobile terminal or personal computer, such electronic information equipment is subjected to the restriction of operating time. Furthermore, there was a problem that since conductor resistance of a sensor electrode is high, a lot of heat is generated in a touch panel, and this generation of heat affects other components (module) in the electronic information equipment equipped with the touch panel, and thus thermal design (design of heat dissipation structure) for such influence of heat is required.

The present invention was conceived in order to solve the above-described issues. The objective of the present invention is to obtain a touch panel module, which can speed up reaction speed for an input operation, lower current consumption, and suppress generation of heat in a sensor electrode by lowering the resistance of the sensor electrode, and as a result, improves responsiveness to a touch operation by speeding up of reaction speed for an input operation, alleviates restriction of operating time in battery-powered equipment by reduction of a current consumption, and reduces influence of heat on peripheral components by suppression of heat generation in the sensor electrode, and to obtain an electronic information equipment equipped with such a touch panel module.

### Solution to Problem

### (Item 1)

A touch panel module according to the present invention is a touch panel module comprising a sensor section for detecting an input operation and a peripheral wiring section disposed at the periphery of the sensor section, wherein: a sensor section substrate constituting the sensor section and a peripheral wiring section substrate constituting the peripheral wiring section are separate substrates; a plurality of sensor section wirings included in the sensor section are of a metal film having lower resistance compared to a conductive film constituting a plurality of peripheral wirings included in the peripheral wiring section; and the conductive film constituting the peripheral wiring is a transparent conductive film having a smaller minimum processing pattern width and a smaller minimum processing pattern pitch compared to the metal film constituting the sensor section wirings, thereby achieving the above-described objective.

### (Item 2)

Preferably, in the touch panel module of item 1 according to the present invention, the plurality of sensor section wirings comprise a plurality of electrodes formed on the sensor section substrate, for detecting the input operation, and a plurality of electrode drawing wires formed on the sensor section substrate, which draw the plurality of electrodes up to a peripheral edge section of the sensor section substrate, wherein the sensor section substrate is overlapped and disposed on The peripheral wiring section substrate such that one end of each of the electrode drawing wires and one end of each of the peripheral wirings oppose to each other, and the opposing one end of each of the electrode drawing wires and one end of each of the peripheral wirings are joined by a nanoparticle material or an anisotropic conductive film.

### (Item 3)

Preferably, in the touch panel module of item 2 according to the present invention, the sensor section substrate is composed of a polymeric sheet, the peripheral wiring section substrate is composed of a glass plate, a metal film constituting the sensor electrodes and the electrode drawing wires is composed of any of copper, silver, gold and aluminum, and a transparent conductive film constituting the peripheral electrodes is composed of Indium in Oxide.

### (Item 4)

Preferably, in the touch panel module of item 2 according to the present invention the peripheral wiring section substrate is installed with a flexible print substrate in which IC chips for performing drive control of the plurality of electrodes of the sensor section are implemented.

### (Item 5)

Preferably, in the touch panel module of item 4 according to the present invention, the plurality of sensor section wirings comprise a plurality of first sensor electrodes extending along a first direction, a plurality of second sensor electrodes extending along a second direction intersecting with the first direction, a plurality of first electrode drawing wires connected to the plurality of first sensor electrodes, and a plurality of second electrode drawing wires connected to the plurality of second sensor electrodes, one end of each of the first electrode drawing wires and one end of each of the second electrode drawing wires are gathered to a specific region in the peripheral wiring section substrate, and wirings of one flexible print substrate implemented with the IC chips are connected to one end of each of the first electrode drawing wires and one end of each of the second electrode drawing wires in a specific region of the peripheral wiring section substrate.

### (Item 6)

Preferably, in the touch panel module of item 2 according to the pre sent invention, the peripheral wiring section substrate is installed with a TAB tape made by equipping a tape member with IC chips for performing drive control of the plurality of electrodes of the sensor section by a tape-automated bonding.

### (Item 7)

Preferably, in the touch panel module of item 6 according to the present invention, the plurality of sensor section wirings comprise a plurality of sensor electrodes extending along a first direction, a plurality of second sensor electrodes extending along a second direction intersecting with the first direction, a plurality of first electrode drawing wires connected to the plurality of first sensor electrodes, and a plurality of second electrode drawing wires connected to the plurality of second sensor electrodes, one end of each of the first electrode drawing wires and one end of each of the second electrode drawing wires are gathered to a specific region in the peripheral wiring section substrate, and wirings of one TAB tape implemented with the control circuit are connected to one end of each of the first electrode drawing wires and one end of each of the second electrode drawing wires in a specific region in the peripheral wiring section substrate.

### (Item 8)

Preferably, in the touch panel module of item 2 according to the present invention, IC chips for performing drive control of the plurality of electrodes of the sensor section are implemented On the peripheral wiring section substrate.

### (Item 9)

A touch panel module according to the present invention is a touch panel module comprising a sensor section for detecting an input operation and a peripheral wiring section disposed at the periphery of the sensor section, wherein substrates constituting the sensor section and the peripheral wiring section are the same insulation substrate, and a plurality of sensor section wirings included, in the sensor section and a plurality of peripheral wirings included in the peripheral wiring section are composed of the same metal film made by depositing metal materials on the insulation substrate, thereby achieving the above-described objective.

### (Item 10)

Preferably, in the touch panel module of item 9 according to the present invention, a metal film constituting the plurality of sensor section wirings and the plurality of peripheral wirings is a metal film made by depositing any of copper, silver, gold and aluminum on the insulation substrate by sputtering or vapor deposition.

### (Item 11)

Preferably, in the touch panel module of item 9 according to the present invention, the plurality of sensor section wirings comprise a plurality of electrodes formed on the insulation substrate, for detecting the input operation, wherein the insulation substrate is installed with a flexible print substrate in which IC chips for performing drive control of the plurality of electrodes of the sensor section are implemented.

### (Item 12)

Preferably, in the touch panel module of item 11 according to the present invention, the plurality of sensor section wirings comprise a plurality of first sensor electrodes extending along a first direction, a plurality of second sensor electrodes extending along a second direction intersecting with the first direction, a plurality of first electrode drawing wires connected to the plurality of first sensor electrodes, and a plurality of second electrode drawing wires connected to the plurality of second sensor electrodes, one end of each of the first electrode drawing wires and one end of each of the second electrode drawing wires are gathered to a specific peripheral edge region of the insulation substrate, and wirings of one flexible print substrate implemented with the IC chips are connected to one end of each of the first electrode drawing wires and one end of each of the second electrode drawing wires in a specific peripheral edge region of the insulation substrate.

### (Item 13)

Preferably, in the touch panel module of item 9 according to the present invention, the plurality of sensor section wirings comprise a plurality of electrodes formed on the sensor section substrate, for detecting the input operation, wherein the insulation substrate is installed with a TAB tape made by equipping a tape member with IC chips for performing drive control of the plurality of electrodes of the sensor section by a ape-automated bonding

### (Item 14)

Preferably, in the touch panel module of item 13 according to the present invention, the plurality of sensor section wirings comprise a plurality of first sensor electrodes extending along a first direction, a plurality of second sensor electrodes extending along a second direction intersecting with the first direction, a plurality of first electrode drawing wires connected to the plurality of first sensor electrodes, and a plurality of second electrode drawing wires connected to the plurality of second sensor electrodes, one end of each of the first electrode drawing wires and one end of each of the second electrode drawing wires are gathered to a specific peripheral edge region of the insulation substrate, and wirings of one TAB tape implemented with the IC chips are connected to one end of each of the first electrode drawing wires and one end of each of the second elect rode drawing wires in a specific region of the peripheral wiring section substrate.

### (Item 15)

Preferably, in the touch panel module of item 9 according to the present invention, the plurality of sensor section wirings comprise a plurality of electrodes formed on the insulation substrate, for detecting the input operation, and the insulation substrate is implemented with IC chips for performing drive control of the plurality of electrodes of the sensor section.

### (Item 16)

An electronic information equipment according to the present invention is an electronic information equipment having an image display sect ion for displaying an image, and an information input section that is disposed on a display screen of the image display section, for inputting information, wherein the information input section comprises a touch panel module of any one of item 1 to item 15, thereby achieving the above-described objective.

### (Item 17)

A manufacturing method of a touch panel module according to the present invention is a method of manufacturing the touch panel module of item 1, the method including the steps of: forming the sensor section substrate comprising the plurality of sensor section wirings; forming the peripheral wiring section substrate comprising the plurality of peripheral wirings; and adhering the sensor section substrate with the peripheral wiring section substrate such that corresponding peripheral, wirings and sensor section wirings are connected, thereby achieving the above-described objective.

### (Item 18)

Preferably, in a manufacturing method of the touch panel module of item 17 according to the present invention connection of the peripheral wirings and the sensor section wirings is performed by joining one end of each of the sensor section wirings and one end of each of the peripheral wirings corresponding to the one end with a nanoparticle material or an anisotropic conductive film.

### (Item 19)

Preferably, in a manufacturing method of the touch panel module of item 17 according to the present invention, the step of forming the sensor section substrate includes a step of forming a plurality of first electrodes extending along a first direction and first electrode drawing wires linked to the first electrodes on a first insulation sheet member to form a first sensor sheet, a step of forming a plurality of second electrodes extending along a second direction and second electrode drawing wires linked to the second electrodes on a second insulation sheet member to form a second sensor sheet, and a step of adhering the first sensor sheet with the second sensor sheet such that the first electrodes arid the second electrodes intersect and are insulated from each other, and the step of forming the peripheral wiring section substrate comprising the plurality of peripheral wirings includes a step of forming the plurality of peripheral wirings on the insulation substrate.

### (Item 20)

The present invention is a method of manufacturing the touch panel module of item 9, the method including a step of depositing metal materials on the insulation on substrate by sputtering or vapor deposition to form a metal film, and a step of patterning the metal film by using a photolithography technique to form the sensor section wirings and the peripheral wirings, thereby achieving the above-described objective.

### (Item 21)

Preferably, in the manufacturing method of the touch panel module of item 20 according to the present invention, first and second film forming steps are included, as the step of forming the metal film, and first and second patterning steps are included as the step of patterning the metal film, the first film forming step is a step of depositing metal materials on the insulation substrate by sputtering or vapor deposition to form a first metal film; the first patterning step is a step of patterning the first metal film by using a photolithography technique to form a plurality of first electrodes extending along a first direction, a plurality of first electrode drawing wires linked to the plurality of first electrodes, and a plurality of first peripheral, wirings linked to the plurality of first electrode drawing wires; the second film forming step is a step of, after forming an insulation film on the first electrodes, the first electrode drawing wires and the first peripheral wirings, depositing metal materials on the insulation film by sputtering or vapor deposition to form a second metal film; and the second patterning step is a step of patterning the second metal film by using a photolithography technique to form a plurality of second electrodes extending in a second direction intersecting with the first direction, a plurality of second electrode drawing wires linked to the plurality of second electrodes, and a plurality of second peripheral wirings linked to the plurality of second electrode drawing wires.

### Advantageous Effects of Invention

According to the present invention, it is possible to realize a touch panel module, which can speed up reaction speed for an input operation, lower a current consumption, and suppress generation of heat in a sensor electrode by reducing the resistance of the sensor electrode, and as a result, improves responsiveness to a touch operation by speeding up reaction speed for an input operation, also alleviates restriction of operating time in battery-powered equipment by reduction of a current consumption, and further reduces influence of heat on peripheral equipment by suppression of heat generation in the sensor electrode, and to realize an electronic information equipment equipped with such a touch panel module.

### BRIEF DESCRIPTION OF THE DRAWINGS

FIG. 1 is a diagram for explaining a touch panel module according to Embodiment 1 of the present invention, which shows the overall structure of this touch panel module.

FIG. 2 is a diagram for explaining a touch panel module according to Embodiment 1 of the present invention, which shows the configuration of a first sensor sheet constituting this touch panel module.

FIG. 3 is a diagram for explaining a touch panel module according to Embodiment 1 of the present invention, which shows the configuration of a second sensor sheet constituting this touch panel module.

FIG. 4 is a diagram for explaining a touch panel module according to Embodiment 1 of the present invention, which shows the configuration of a sensor section substrate constituting This touch panel module.

FIG. 5 is a diagram for explaining a touch panel module according to Embodiment 1 of the present invention, which shows the configuration of a peripheral wiring section substrate constituting this touch panel module.

FIG. 6 is a diagram for explaining a touch panel module according to Embodiment 1 of the present invention, FIG. 6 (a), shows the enlarged A1 portion of FIG. 1, and FIG. 6 (b) schematically shows a cross-sectional structure at the A6-A6 line portion of FIG. 6 (a).

FIG. 7 is a diagram for explaining a touch panel module according to Variation 1 of Embodiment 1 of the present invention, which shows the overall structure of this touch panel module.

FIG. 8 is a diagram for explaining a touch panel module according to Variation 1 of Embodiment 1 of the present invention, which shows the enlarged A7 portion of FIG. 7.

FIG. 9 is a diagram for explaining a touch panel module according to Variation 2 of Embodiment 1 of the present invention, which shows the overall structure of this touch panel module.

FIG. 10 is a diagram for explaining a touch panel module according to Variation 2 of Embodiment 1 of the present invention, which shows the enlarged A9 portion of FIG. 9.

FIG. 11 is a diagram for explaining a touch panel module according to Variation 3 of Embodiment 1 of the present invention, which shows the overall structure of this touch panel module.

FIG. 12 is a diagram for explaining a touch panel module according to Variation 3 of Embodiment 1 of the present invention, FIG. 12 (a) and FIG. 12 (b) show an electrode pad of an IC chip and a connection pad of a peripheral wiring section substrate, respectively, FIG. 12 (c) shows a state in which the electrode pad of the IC chip is connected to the connection pad of the peripheral wiring section substrate, and FIG. 12 (d) shows a cross-sectional, structure at the A12c-A12c portion of FIG. 12 (c).

FIG. 13 is a diagram for explaining a touch panel module according to Embodiment 2 of the present invention, which shows the overall structure of this touch panel module.

FIG. 14 is a diagram for explaining a touch panel module according to Embodiment 2 of the present invention, wherein FIG. 14 (a) is a partially-fractured perspective view showing the enlarged B13 portion of FIG. 13, and FIG. 14 (b) is a cross-sectional view of the B14-B14 line portion of FIG. 14 (a)

FIG. 15 is a diagram for explaining a manufacturing method of a touch panel module according to Embodiment 2 of the present invention, which shows a state in which a first sensor section wiring and a first peripheral, wiring constituting this touch panel, module are formed.

FIG. 16 is a diagram for explaining a touch panel module according to Variation 1 of Embodiment 2 of the present invention, which shows the overall structure of this touch panel module.

FIG. 17 is a diagram for explaining a touch panel module according to Variation 2 of Embodiment 2 of the present invention, which shows the overall structure of this touch panel module.

FIG. 18 is a diagram for explaining a touch panel module according to Variation 3 of Embodiment 2 of the present invention, which shows the overall structure of this touch panel module.

FIG. 19 is a block diagram showing a schematic configuration example of an electronic information equipment. (information-processing device) using at least one of a touch panel module according to Embodiment 1, and Variations 1 and 2 thereof; and Embodiment 2, and Variations 1 and 2 thereof, for an input operation section, as Embodiment 3 of the present invention.

FIG. 20 is a diagram for explaining a conventional touch panel module, which shows the overall structure of this touch panel module.

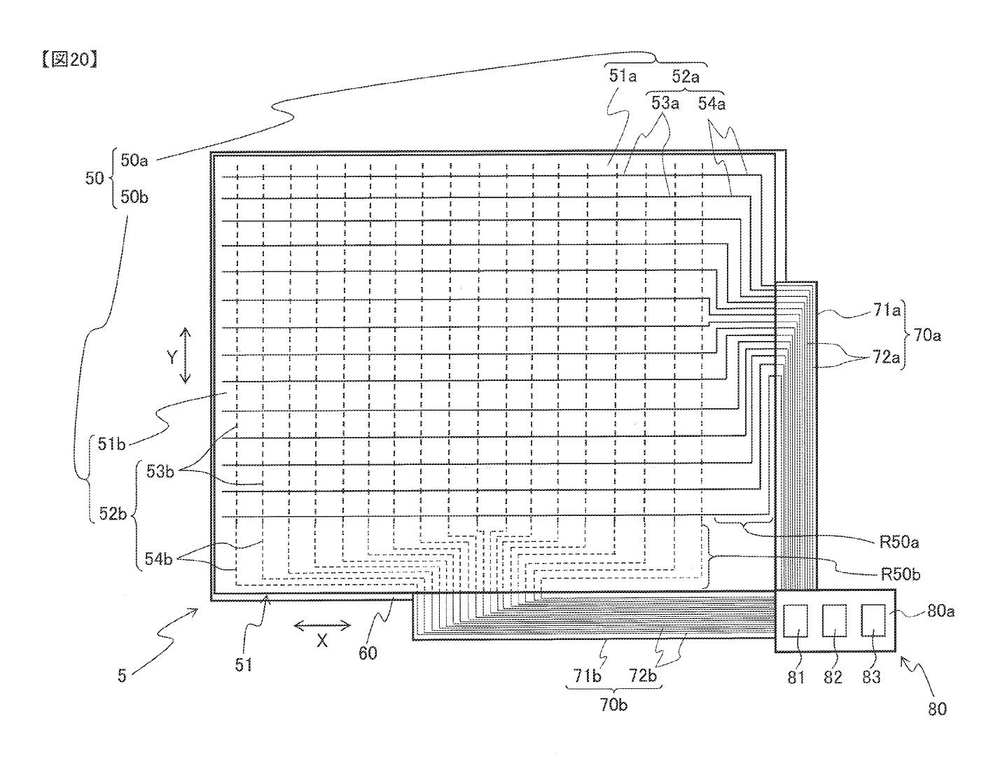

### DESCRIPTION OF EMBODIMENTS

The basic principles of the present invention will be explained.

### [Premise Technique of the Present Invention]

In conventional touch panels, there were problems, for example, a problem that reaction speed for an input operation is slow; a problem that there is a lot of current consumption; and a problem that electronic information equipment equipped with a touch panel is affected by generation of heat in the touch panel. These problems are dependent on how much conductor resistance values of conductive members constituting sensor section wirings can be lowered.

Thus, as a method of lowering conductor resistance of sensor section wirings, the inventor discovered a method of lowering conductor resistance of sensor section wirings by replacing a transparent and conductive ITO (Indium Tin Oxide) film, which was used as a conductive material in a sensor electrode in conventional touch panels, with Cu, Ag, Au, Al or other economical materials having low conductor resistance.

By lowering conductor resistance values of sensor section wirings in this mariner, it becomes possible to: speedup reaction speed for an input operation in a touch panel; lower an operating current, that is, reduce current consumption; and suppress generation of heat, thereby solving the problems in the conventional art.

Meanwhile, formation of a metal film on an insulation substrate such as a glass substrate or a polymeric sheet is preferably performed not with a vapor growth method such as sputtering or vapor deposition but with a plating method in view of manufacturing cost (for example, the cost of a processing device and the length of processing time). However, a minimum pattern width and a minimum pattern pitch that are obtained by a patterning with a photolithography technique of a metal film formed with a plating method are larger compared to those of a metal film formed with a vapor growth method. Thus, when peripheral wirings are disposed at the periphery of a sensor section in the same amount as the amount of sensor section wirings, the peripheral region becomes wider, and thereby a recent tendency of attaining a narrow frame is inhibited.

A minimum wiring width and a minimum wiring pitch obtained by a patterning of a metal film formed by a plating method being larger compared to those of a metal film formed by a vapor growth method is associated with adhesion of a metal film with a foundation layer and compactness of a metal film itself.

That is, in a metal film, formed by a vapor growth method, adhesion of the metal film with a foundation layer and compactness of the metal film itself are higher compared to a metal film by a plating method. For example, at the time of selective etching of a metal film obtained by a vapor growth method, compared to selective etching of a metal film obtained by a plating method, the metal film constituting a wiring with narrow line width is less likely to come off, and adjacent wirings can be certainly separated with a narrow space even if a space between the adjacent wirings is small.

### [First Invention of the Present Application]

Thus, as a result of further earnest research, the inventor has conceived the following as the present invention: a touch panel module, wherein only a wiring (sensor section wiring) of a sensor section for detecting an input operation is formed by a low-resistance metal film formable with a plating method, and a peripheral wiring disposed at the periphery of the sensor section is formed by a transparent conductive material such as an ITO film to be formed by sputtering or vapor deposition, which allows a minimum pattern width and a minimum pattern pitch to be smaller compared to the metal material constituting the sensor section wiring.

In the present invention having such a configuration, a plating method of a metal film which is advantageous in view of manufacturing cost can be used for formation of a sensor section wiring. Further, a transparent conductive film such as an ITO film formed with sputtering or vapor deposition is used for a peripheral wiring to allow a minimum pattern width and a minimum pattern pitch to be narrower than those of a metal film by a plating method, Thereby not inhibiting attainment of a narrow frame in a touch panel.

For example, in an embodiment of the present invention, a metal film is formed by plating Cu, Ag, Au, Al, or other low-resistance metal material as a constituent material of a sensor section wiring on a sensor section substrate such as a polymeric sheet (PET or the like) Thereby, low resistance of a wiring of a sensor section can be enhanced, and manufacturing cost can be reduced compared to a case an which formation of a metal film is performed with sputtering or vapor deposition.

In addition, in an embodiment of the present invention, a wiring constituting a section other than a sensor section, that is, a peripheral wiring, is formed on a peripheral, wiring section substrate (for example, a glass substrate or a polymeric sheet) by a transparent conductive film by sputtering or vapor deposition that is able to make a wiring width and a wiring pitch narrow, such as an ITO film. Thereby, a touch panel module and a product (that is, electronic information equipment comprising a touch panel module) can be made small in size.

In this manner, in a touch panel module, a metal material such as Cu, Ag, Au or Al is used for a sensor section wiring, and a wiring material such as an ITO film that is able to attain narrow wiring (fine patterning) is used for a peripheral wiring, thereby enhancing a narrow frame in the touch panel by miniaturization of the peripheral wiring while also enhancing low resistance of the wiring of the sensor section. However, in this case, there is a need no connect the sensor section wiring consisting of Cu, Ag, Au, Al or other low-resistance metal material of the sensor section, and the peripheral wiring consisting of a transparent conductive material such as an ITO on a glass substrate of the peripheral wiring section.

Thus, as the present invention, the inventor has conceived a toucan panel module in which a wiring (sensor section wiring) constituting a sensor section and a wiring (peripheral wiring) positioned at the periphery of the sensor section are formed with different materials, wherein an anisotropic conductive film or a nano paste (nanoparticle material) is used for joining of these sensor section wiring and peripheral wiring thereby allowing the joining of the sensor section wiring and the peripheral wiring having different constituent materials with a simple method and thereby allowing the joining to be highly reliable.

Further, with respect to touch panel modules wherein a sensor section wiring is composed of a metal material and a peripheral wiring is composed of a transparent conductive material such as an ITO film, the inventor has discovered that a high-performance, small-sized and low-cost touch panel module can be created by installing an integrated circuit as IC chips such as a driver IC, a controller IC and a power source IC on a substrate where a sensor section wiring and a peripheral wiring are formed.

In this manner, the present invention is able to obtain a touch panel module attaining: speed up of reaction speed; low current, that is, reduction in current consumption; suppression of generation of heat; small size; and low cost in a touch panel.

### [Second Invention of the Present Application]

From a viewpoint that is different From the viewpoint that formation of a metal film on an insulation substrate such as a glass substrate or a polymeric sheet is preferably performed not with a vapor growth method such as sputtering or vapor deposition but with a plating method in view of manufacturing cost (for example, the cost of a processing device and the length of processing time), the inventor has conceived the following as the present invention in order to decrease a conductor resistance value of a sensor section wiring while also enhancing reduction of manufacturing process in a touch panel module. In the touch panel module according to the present invention, a sensor section and a peripheral, wiring section are formed on the same insulation substrate, and a plurality of sensor section wirings included in the sensor section and a plurality of peripheral wirings included in the peripheral wiring section are composed of the same metal film made by depositing metal materials on the insulation substrate.

In the present invention having such a configuration, a sensor section wiring and a peripheral wiring are simultaneously formed on a single insulation substrate, that is, film formation and patterning of a metal film constituting a sensor section wiring and a peripheral wiring can be performed at the same time in forming the sensor section wiring and the peripheral wiring. Such commonalization of formation process of a sensor section wiring and a peripheral wiring allows reduction of the manufacturing process, and a disposition region of the peripheral wiring can be made narrower while enhancing low resistance of the sensor section wiring.

In an embodiment of the present invention, for example, a metal film made by depositing a conductive material such as Cu, Ag, Au or Al on the same polymeric sheet or the same glass plate by sputtering or vapor deposition is used for a sensor section wiring and a peripheral wiring. Thereby, low resistance of a sensor section wiring is enhanced, and a wiring width and a wiring pitch of a peripheral wiring can be made narrower compared to a case of using a metal film by plating for a peripheral wiring, Further, it becomes possible to make a sensor section wiring and a peripheral wiring by the same process, and thereby the manufacturing process can be reduced. As a result, it is possible to realize high-performance and low-priced touch panel module.

Furthermore, with respect so touch panel modules wherein a sensor section wiring and a peripheral wiring are composed of a metal film formed by sputtering or vapor deposition, the inventor has discovered that a high-performance, small-sized and low-cost touch panel module can be manufactured by mounting integrated circuits as IC chips such as a driver IC, a controller IC and a power source IC on a common substrate of the sensor section wiring and the peripheral wiring.

Hereinafter, Embodiments of the present invention are explained while referring to the drawings.

### Embodiment 1

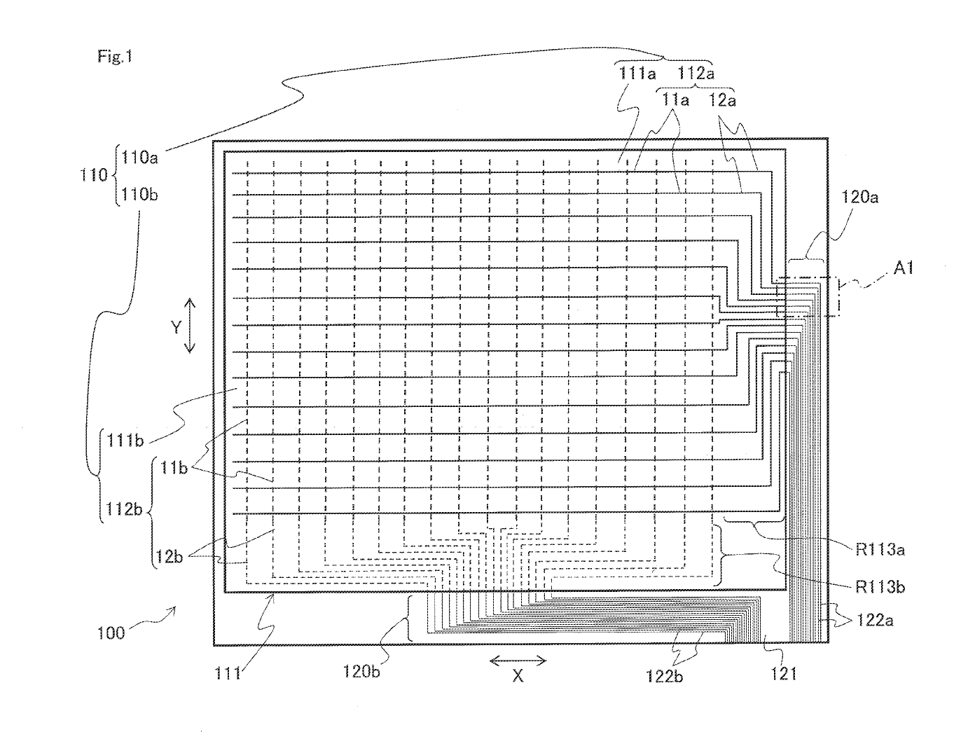

FIG. 1 is a diagram for explaining a touch panel module according to Embodiment 1 of the present invention, which shows the overall structure of this touch panel module.

A touch panel module 100 of Embodiment 1 comprises a sensor section 110 that detects an input, operation, and peripheral wiring sections 120a and 120b disposed at the periphery of this sensor section 110. Herein, the sensor section 110 is formed by adhering a first sensor sheet 110a with a second sensor sheet 110b.

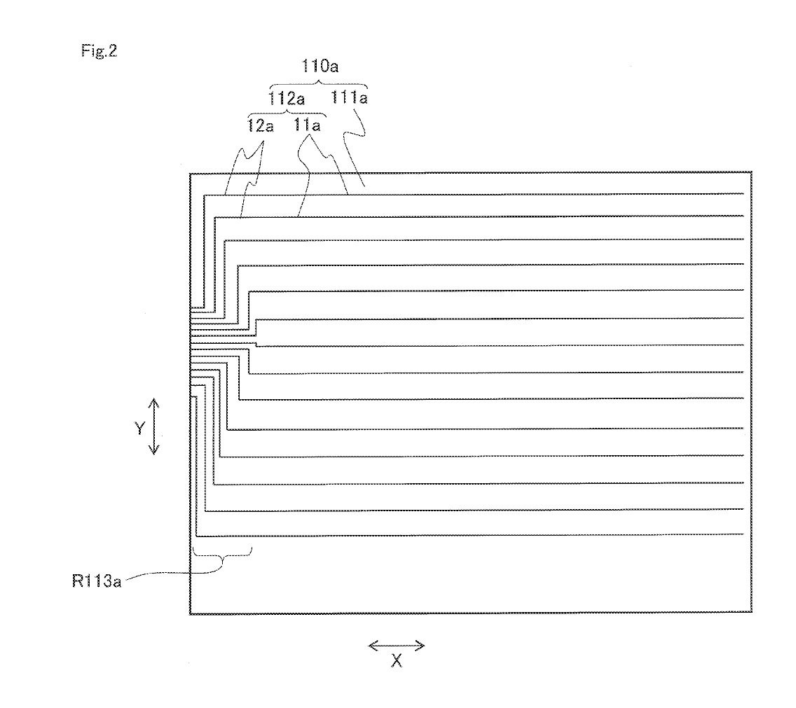

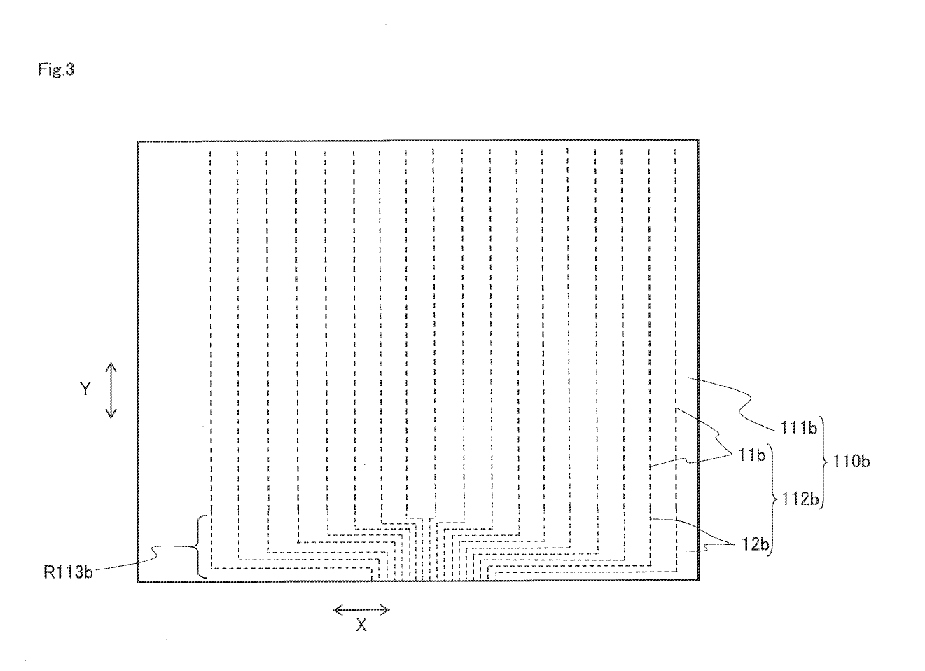

FIG. 2 and FIG. 3 are diagrams for explaining a touch panel module according to Embodiment 1 of the present invention, FIG. 2 and FIG. 3 show the configurations of first and second sensor sheets constituting this touch panel, module, respectively.

As shown in FIG. 2, the first sensor sheet 110a is, for example, a sheet in which a plurality of first sensor section wirings 112a are formed on a first insulation sheet substrate 111a, which is a polymeric sheet, and the first sensor section wirings 112a are constituted of first sensor electrodes 11a formed on the insulation sheet substrate 111a such that they extend along a X direction (horizontal direction), and first electrode drawing wires 12a that draw these first sensor electrodes 11a to the peripheral edge of the insulation sheet substrate 111a, respectively. Further, in the figure, R113a is a disposition region of the first electrode drawing wires 12a on the first insulation sheet substrate 111a

As shown in FIG. 3, the second sensor sheet 110b is, for example, a sheet in which a plurality of second sensor section wirings 112b are formed on a second insulation sheet substrate 111b, which is a polymeric sheet, and the second sensor section wirings 112b are constituted of, second sensor electrodes 11b formed on the insulation sheet substrate 111b such that they extend along a Y direction (vertical direction), and electrode drawing wires 12b that draw these second sensor electrodes 11b to the peripheral edge of the insulation sheet substrate 111b, respectively. Further, in the figure, R113b is a disposition region of the second electrode drawing wires 12b on the second insulation sheet substrate 111b.

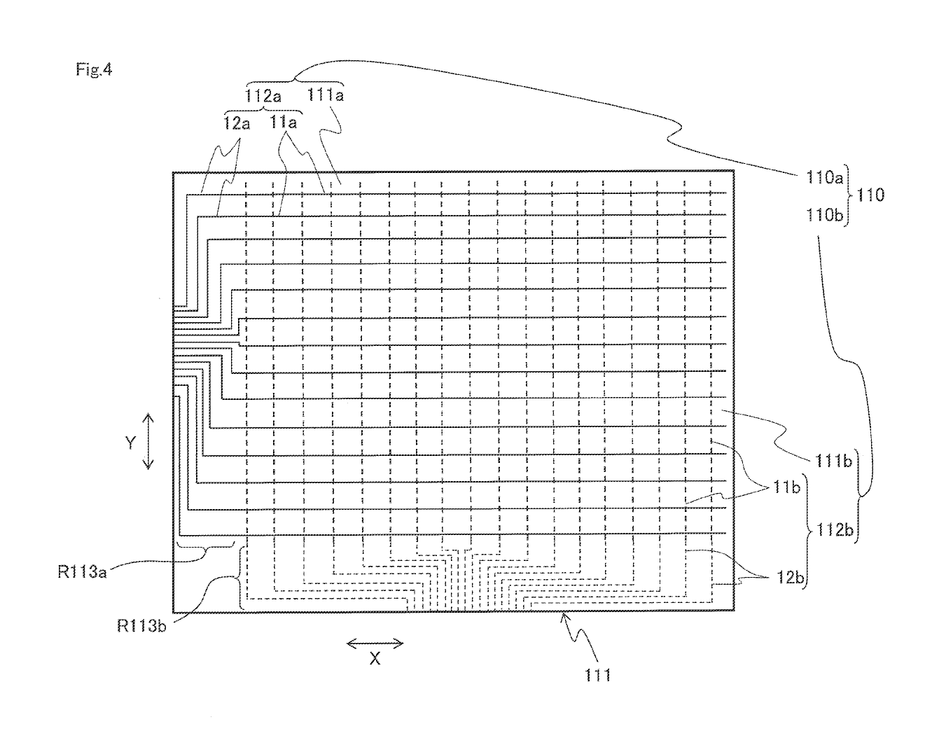

As shown in FIG. 4, the first and second sensor sheets 110a and 110b having such structures are adhered such that the first sensor electrodes 11a and the second sensor electrodes 11b are orthogonal, to form a sensor section 110, and the first and second insulation sheet substrates 111a and 111b forma sensor section substrate 111. Further, in this embodiment, the second sensor sheet 110b is overlapped on the first sensor sheet 110a and the first sensor section wirings 112a and the second sensor section wirings 112b are insulated by the second insulation sheet substrate 111b.

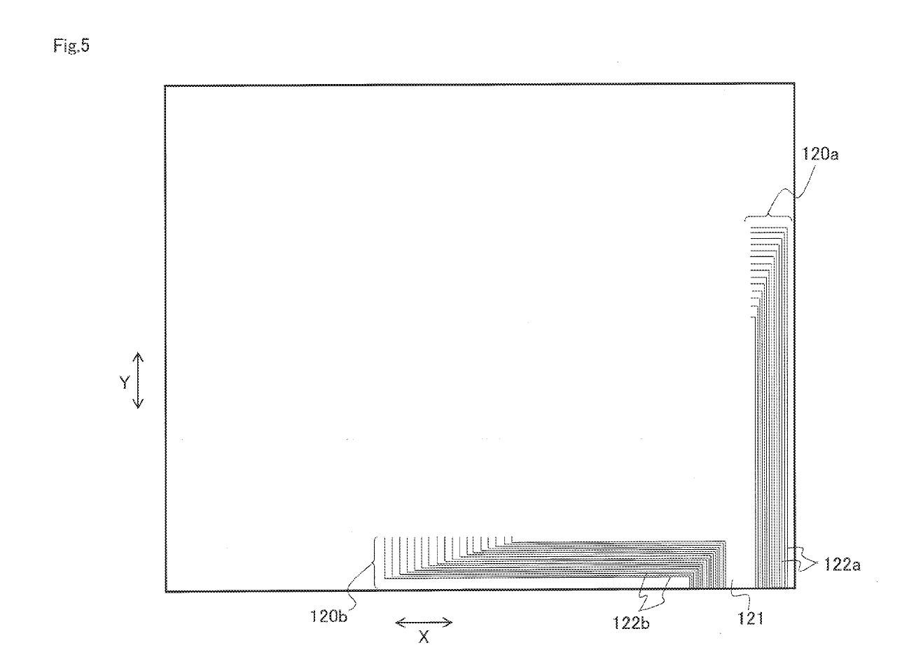

In addition, as shown in FIG. 5, a peripheral wiring section 120a comprises a plurality of first peripheral wirings 122a which are formed in a peripheral edge sect ion of an insulation substrate 121 which is, for example, a glass substrate, and are connected to the plurality of first electrode drawing wires 12a. As shown in FIG. 5, a peripheral, wiring section 120b comprises a plurality of second peripheral wirings 122b which are formed in a peripheral edge section of the insulation substrate 121, and are connected to the plurality of second electrode drawing wires 12b.

Further, the sensor section substrate 111 having a structure in which the second sensor sheet 110b is overlapped on the first sensor sheet 110a, is overlapped and adhered on this insulation substrate 121 such that one end of each of the first electrode drawing wires 12a oppose one end of each of the first peripheral wirings 122a, and one end of each of the second electrode drawing wires 12b oppose to one end of each of the second peripheral wirings 122b, thereby forming the touch panel module 100 shown in FIG. 1. That is, the sensor section substrate 111 shown in FIG. 4 is turned over and adhered on the insulation substrate 121 such that a surface of the second sensor sheet 110b where the second sensor section wirings 112b are formed shown in FIG. 4 faces a surface of the insulation substrate 121 where the peripheral wirings 122a and 122b are formed.

In this manner, in the touch panel module 100 of Embodiment 1, the sensor section substrate 111 (that is, the insulation sheet substrates 111a and 111b) constituting the sensor section 110 and the peripheral wiring section substrate (insulation substrate) 121 constituting the peripheral wiring sections 120a and 120b are separate substrates. In addition, the plurality of sensor section wirings 112a and 112b included in the sensor section 110 are metal materials having lower resistance compared to conductive material s constituting the plurality of peripheral wirings 122a and 122b included in the peripheral wiring sections 120a and 120b. Also, conductive materials constituting the peripheral wirings 122a and 122b are transparent conductive materials having a minimum patterning width and a minimum patterning pitch smaller than those of metal materials constituting the sensor section wirings 112a and 112b. For example, metal materials constituting the sensor section wirings 112a and 112b (the first and second sensor electrodes 11a and 11b, and the first and second electrode drawing wires 12a and 12b) are copper. However, metal materials constituting the sensor section wirings 112a and 112b are not limited to copper, but they may be silver, gold, aluminum or other low-resistance metal material. In addition, transparent conductive materials constituting the peripheral wirings 122a and 122b are indium tin oxide (ITO). Herein, the line width of a peripheral wiring is 100 μm-200 μm, and the wiring pitch of a peripheral wiring is 150 μm-500 μm. Further, in this Embodiment 1, for example, the line width of the peripheral wiring is 100 μm, and the wiring pitch of the peripheral wiring is about 300 μm.

In addition, the opposing one end of each of the electrode drawing wires 12a and 12b and one end of each of the peripheral wirings 122a and 122b are joined with a nano paste (nanoparticle material) or an anisotropic conductive film.

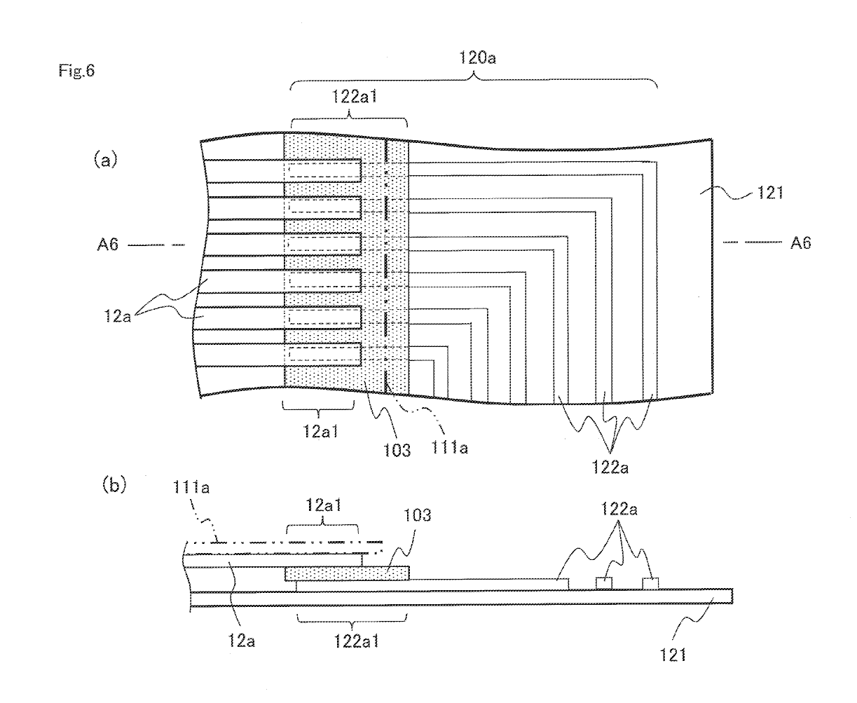

FIG. 6 is a diagram for explaining a structure of joining portions of one end of an electrode drawing wire with one end of a peripheral wiring, FIG. 6 (a) shows the enlarged A1 portion of FIG. 1, and FIG. 6 (b) schematically shows a cross-sectional structure at the A6-A6 line portion of FIG. 6(a).

As shown in FIGS. 6 (a) and 6 (b), one end 12a1 of each of the first electrode drawing wires 12a and one end 122a1 of each of the first peripheral wirings 122a are disposed such that they oppose to each other, and an anisotropic conductive film 103 is formed on the one end 122a1 of each of the first peripheral wirings 122a. The one end 12a1 of each of the first electrode drawing wires 12a are electrically and mechanically joined to the one end 122a1 of each of the first peripheral wirings 122a by this anisotropic conductive film 103. This anisotropic conductive film 103 is a connection material in a film form that is obtained by uniformly dispersing conductive particles in thermoset resin, the conductive particles are made by covering a plastic nucleus with two layers of nickel and gold, and they have a particle size of about 10 nm-100 nm. This anisotropic conductive film 103 is, for example, inserted between the one end 12a1 of each of the first electrode drawing wires 12a and the one and 122a1 of each of the first peripheral wirings 122a and is pressed and heated, and thereby the two are electrically connected by the conductive particles, and also mechanically joined by thermoset resin in a portion where pressure is applied, that is, a portion in which the one end 12a1 of each of the first electrode drawing wires 12a and the one end 122a1 of each of the first peripheral wirings 122a oppose each other. This anisotropic conductive film 103 is not only in a film form, but is also in a paste form (anisotropic conductive paste) that is used in the same way as the film form.

In addition, a nano paste (nanoparticle material) may be used instead of an anisotropic conductive film or an anisotropic conductive paste. This nano paste is composed of a metal nanoparticle, a solvent or the like. Since a metal nanoparticle for example, a nanoparticle of gold) has a small particle size, the metal nanoparticle melts In a lower melting temperature (about 100° C.-250° C.) compared to the usual melting temperature (about 1000° C.) of gold. Thus, joining of wirings using a nano paste can be performed by a relatively low temperature.

Further, when overlapping the second sensor sheet 110b on the first sensor sheet 110a, in order to avoid a state in which the one end 12a1 of each of the first electrode drawing wires 12a of the first sensor sheet 110a are covered with the insulation sheet substrate 111b of the second sensor sheet 110b and thereby the one end 12a1 of each of the first electrode drawing wires 12a do not come into contact with the one end 122a1 of each of the first peripheral wirings 122a, a notch (not shown) is formed in a portion corresponding to the one end 12a1 of each of the first electrode drawing wires 12a of the second sensor sheet 110b such that the one end 12a1 of each of the first electrode drawing wires 12a are exposed even in a state in which the second sensor sheet 110b is overlapped on the first sensor sheet 110a.

FIG. 6 shows a connection structure of the one end 12a1 of each of the first electrode drawing wires 12a and the one end 122a1 of each of the first peripheral wirings 122a. In this regard, a connection structure of one end of each of the second electrode drawing wires 12b and one end of each of the second peripheral wirings 122b also has the same structure as that shown in FIG. 6.

Next, a manufacturing method of a touch panel module of Embodiment 1 will be explained.

Firstly, a metal film is formed by, for example, Cu plating, on the first insulation sheet substrate 111a consisting of a polymeric sheet such as PET (polyethylene terephthalate), and a patterning of this metal film is performed by a photolithography technique to form the plurality of first sensor electrodes 11a extending in the X direction, and the plurality of first electrode drawing wires 12a linked to these first sensor electrodes 11a. Herein, one of the first sensor electrodes 11a and one of the first electrode drawing wires 12a linked to this, form one first sensor section wiring 112a. Thereby, the first sensor sheet 110a comprising the plurality of first sensor section wirings 112a is completed (see FIG. 2).

Similarly, a metal film is formed by, for example, Cu plating, on the second insulation sheet substrate 112b consisting of a polymeric sheet such as PET, and a patterning of this metal film is performed by a photolithography technique to form the plurality of second sensor electrodes 11b extending in the Y direction, and the plurality of second electrode drawing wires 12b linked to these second sensor electrodes 11b. Herein, one of the second sensor electrodes 11b and one of the second electrode drawing wires 12b linked to this, form one second sensor section wiring 112b. Thereby, the first sensor sheet 110b comprising the plurality of second sensor section wirings 112b is completed (see FIG. 3).

Then, the second sensor sheet 110b is adhered on the first sensor sheet 110a such that the first sensor electrodes 11a and the second sensor electrodes 11b are orthogonal, to form the sensor section 110. In this state, the sensor section substrate 111 of the sensor section 110 is formed by the first and second insulation sheet substrates 112a and 112b (see FIG. 4).

On the other hand, an ITO film is formed on the peripheral wiring section substrate (insulation substrate) 121 such as a glass substrate by a method such as sputtering or vapor deposition, and a patterning of this ITC) film is performed by a photolithography technique to form the first peripheral wirings 122a connected to the first electrode drawing wires 12a and the second peripheral wirings 122b connected to the second electrode drawing wires 12b. Thereby, the peripheral wiring sections 120a and 120b are created (see FIG. 5).

Thereafter, the sensor section substrate 111 is overlapped and adhered on the peripheral wiring section substrate 121 shown in FIG. 5 such that a surface of the sensor section substrate 111 shown in FIG. 4 faces a surface of the peripheral wiring section substrate 121. At this time, as shown in Figure 6(a) and FIG. 6(b), one end of each of the peripheral wirings 122a and 122b of the peripheral wiring section substrate 121 (that is, an end on the sensor section substrate 111 side) and one end or each of the first and second electrode drawing wires 12a and 12b of the sensor section substrate 111 that is, an outer peripheral side end of the sensor section substrate 111) are heated and pressed in a state in which the anisotropic conductive film 103 is inserted therebetween.

Thereby, the first electrode drawing wires 12a of the sensor section 110 and the first peripheral wirings 122a are connected, and the second electrode drawing wires 12b of the sensor section 110 and the second peripheral wirings 122b are connected, and the touch panel module 100 shown in FIG. 1 is completed.

In this manner in Embodiment 1, since the first and second sensor section wirings 112a and 112b constituting the sensor section 110 are composed of metal materials (Cu), conductor resistance of the sensor section wirings 112a and 112b can be lowered. As a result, by attaining such low resistance of the sensor section wirings, it is possible to: speed up reaction speed for an input operation in the touch panel; lower an operating current, that is, reduce current consumption; and suppress generation of heat.

In addition, in Embodiment 1, a plating method of a metal film that is advantageous in view of manufacturing cost may be used for the formation of the sensor section wirings.

Moreover, in Embodiment 1, since a transparent conductive film by sputtering or vapor deposition such as an ITO film is used for the peripheral wirings 122a and 122b, a minimum patterning width and a minimum patterning pitch can be made narrower than those of a metal film by a plating method, and thus an area occupied by the peripheral wiring sections 120a and 120b in a peripheral edge section of the insulation substrate 121 is kept small, thereby enabling not to inhibit attainment of a narrow frame of the touch panel.

In addition, since an anisotropic conductive film or a nano paste is used for joining one end of each of the electrode drawing wires 12a and 12b of the sensor section wirings 112a and 112b (input/output electrodes of the sensor sheets 110a and 110b) to one end of each of the peripheral wirings (input/output electrodes of the glass substrate), good connectivity is obtained between the sensor section wirings and the peripheral wirings, and low-cost connection is enabled.

### Variation 1 of Embodiment 1

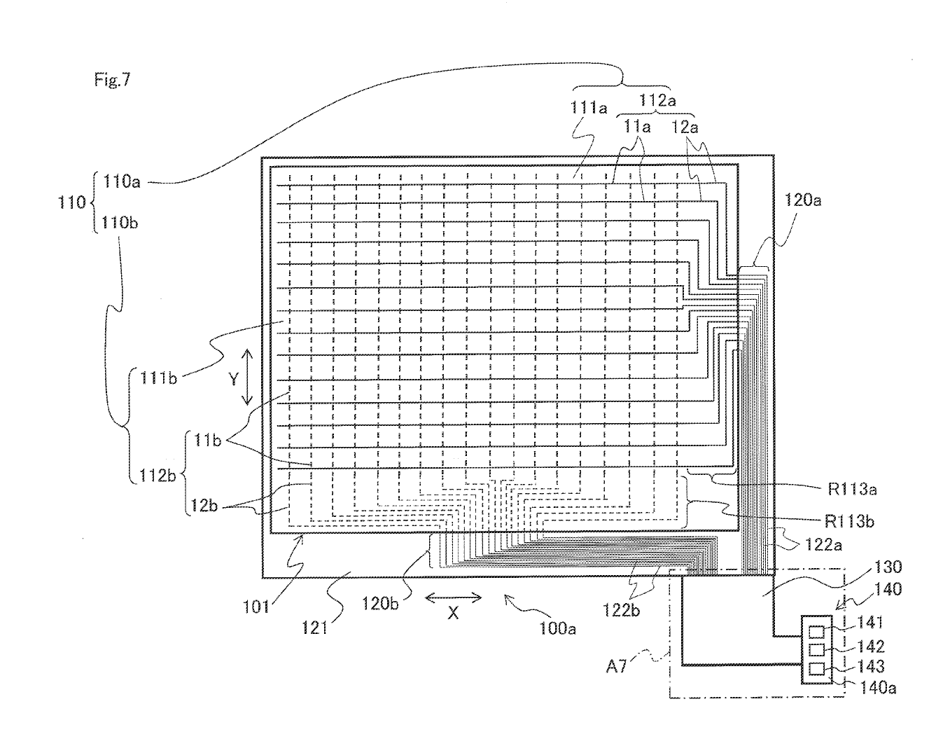

FIG. 7 is a diagram for explaining a touch panel module according to Variation 1 of Embodiment 1 of the present invention, which shows the overall structure of this touch panel module.

A touch panel module 100a according to Variation 1 of Embodiment 1 is a module obtained by installing a flexible print substrate 130 in the above-described peripheral wiring section substrate (insulation substrate)121 in the touch panel module 100 of Embodiment 1. In the flexible print substrate 130, a plurality of IC chips 141-143 for performing drive control of the plurality of first sensor electrodes 11a and the plurality of second sensor electrodes 11b of the sensor section 110 are implemented.

In this Variation, for example, the IC chip 141 is a driving IC for driving the first and second sensor electrodes 11a and 11b; the IC chip 142 is a controlling IC for controlling the IC chip 141; and the IC chip 143 is a power source IC for generating a voltage necessary for performing drive control of the sensor electrodes.

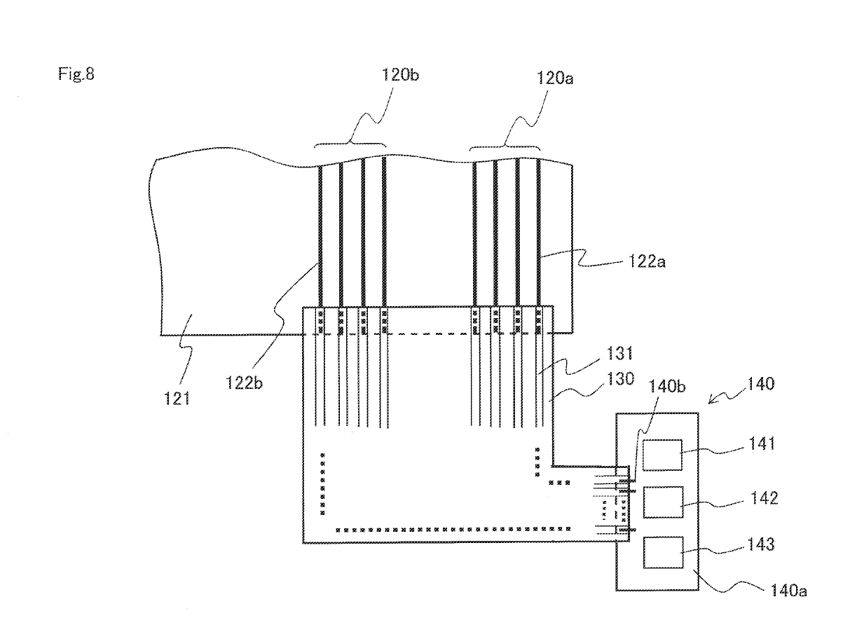

FIG. 8 is a diagram for explaining a touch panel module according to Variation 1 of Embodiment 1 of the present invention, which shows the enlarged A7 portion of FIG. 7.

The connection between the flexible print substrate (FPC substrate) 130 and the peripheral wiring section substrate 121 is performed by joining one end of each of wirings 131 of the flexible print substrate 130 with one end (ends on the side that is connected with an external circuit) of each of the peripheral wirings 122a and 122b formed in the peripheral wiring section substrate 121 by using an anisotropic conductive film, a nanoparticle paste or the like. In particular, in this variation, one end of each of the first and second peripheral wirings 122a and 122b are gathered to a part of the region of the insulation substrate 121 (for example, one corner among the four corners of the insulation substrate), and in this corner, the ends of the wirings 131 of one FCC substrate 130 are connected to the one end of each of the first and second peripheral wirings 122a and 122b.

In addition, the connection between the FCC substrate 130 and the IC chips 141-143 is performed by joining electrode terminals 140b of an IC substrate module 140 made by installing the IC chips 141-143 in a print substrate 140a or the like, with other ends of the wirings 131 of the FCC substrate 130 by using an anisotropic conductive film, a nanoparticle paste or the like.

In this Variation 1 of Embodiment 1, one end of each of the first and second peripheral wirings 122a and 122b (ends on the side that is connected with an external circuit) are gathered to a part of the region of the insulation substrate 121 (for example, one corner among the four corners of the insulation substrate), and in this corner, the ends of the wirings 131 of the FPC substrate 130 are connected to the one end of each of the first and second peripheral wirings 122a and 122b. Thus, the FPC substrate 130 installed in the insulation substrate 121 of the touch panel module can be realized by one substrate.

### Variation 2 of Embodiment 1

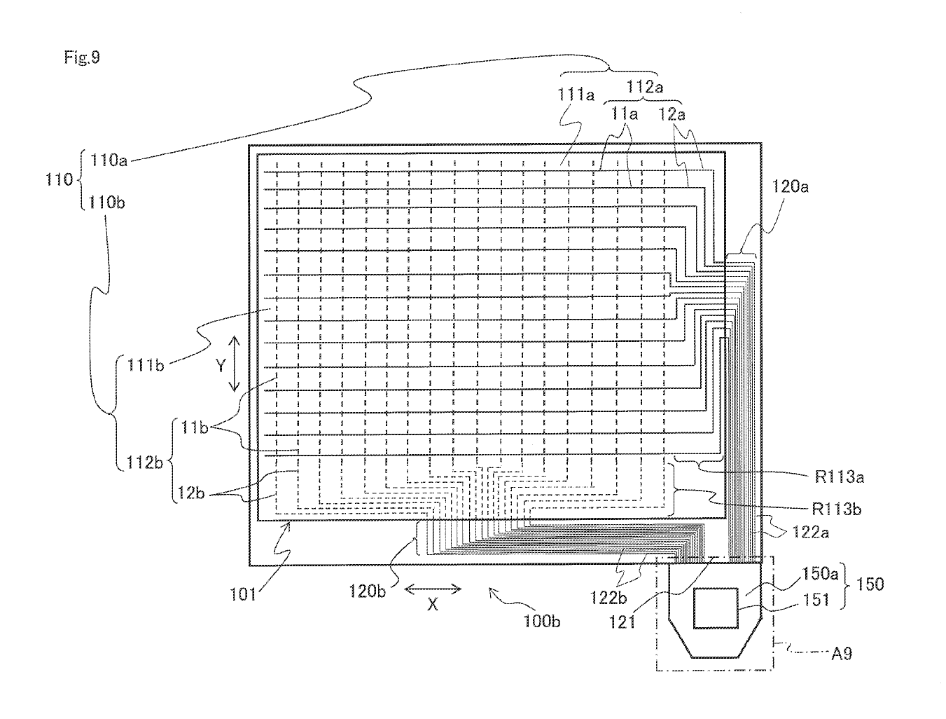

FIG. 9 is a diagram for explaining a touch panel module according to Variation 2 of Embodiment 1, of the present invention, which shows the overall structure of this touch panel module.

A touch panel module 100b according to this Variation 2 of Embodiment 1 is a module obtained by installing a TAB tape 150 in the above-described peripheral wiring section substrate (insulation substrate) 121 in the touch panel module 100 of Embodiment 1. This TAB tape 150 is made by equipping a tape member 150a with a drive control IC 151 for performing drive control of the plurality of first sensor electrodes 11a and the plurality of second sensor electrodes fib of the above-described sensor section 110, by a tape-automated bonding (TAB).

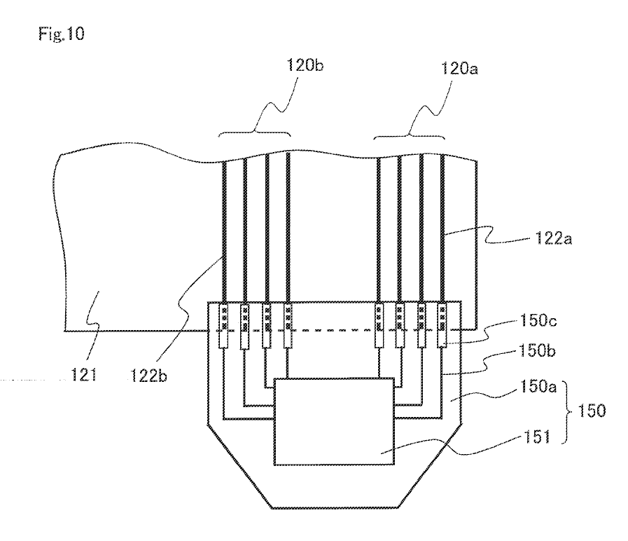

FIG. 10 is a diagram for explaining a touch panel module according to Variation 2 of Embodiment 1 of the present invention, which shows the enlarged A9 portion of FIG. 9.

This TAB tape 150 is installed in the peripheral wiring section substrate 121 by joining connection pads 150c formed on one end side of the wirings 150b of the TAB tape 150 with the ends of the peripheral wirings 122a and 122b formed in the peripheral wiring section substrate 121, by using an anisotropic conductive film, a nanoparticle paste or the like.

Also in Variation 2 of Embodiment 1 having such a configuration, as in the case of Variation 1 of Embodiment 1, one end of each of the first and second peripheral wirings 122a and 122b (ends on the side that is connected with an external circuit) are gathered to a part of the region of the insulation substrate 121 (for example, one corner among the four corners of the insulation substrate), and in this corner, the connection pads 150c of the wirings 150b of the TAB tape 150 are connected to one end of each of the first and second peripheral wirings 122a and 122b. Thus, the TAB tape 150 installed in the peripheral wiring section substrate 121 of the touch panel module can be realized by one tape.

### Variation 3 of Embodiment 1

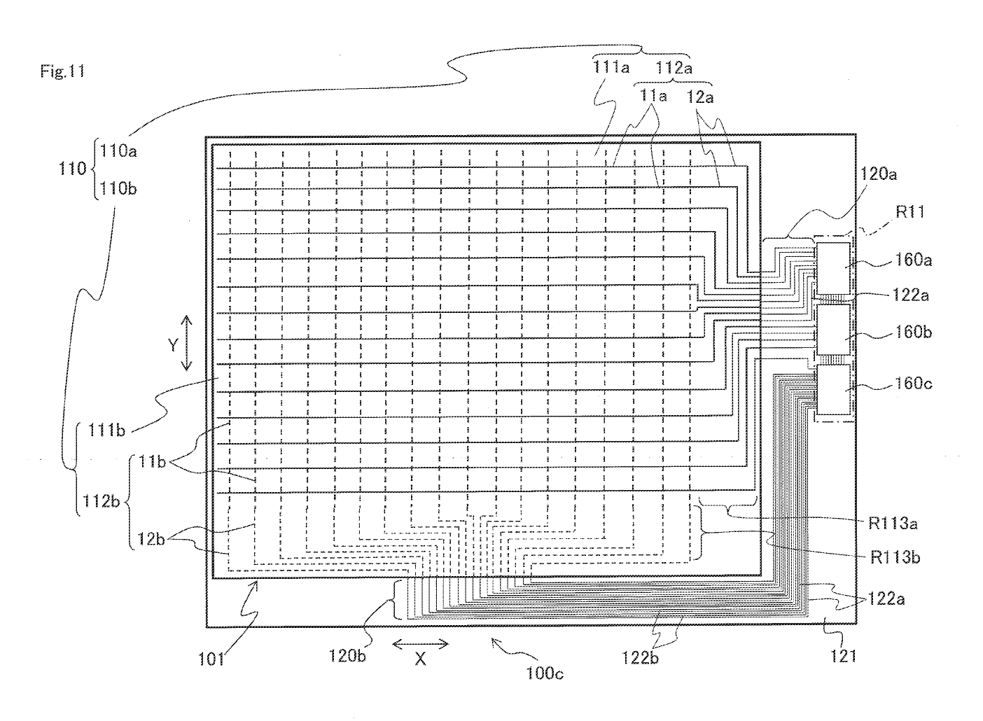

FIG. 11 is a diagram for explaining a touch panel module according to Variation 3 of Embodiment 1 of the present invention, which shows the overall structure of this touch panel module.

A touch panel module 100c of this Variation 3 of Embodiment 1 is a module obtained by, in the touch panel module 100 of Embodiment 1, securing a disposition region of IC chips on the external side of the peripheral wiring section 120a on the above-described peripheral wiring section substrate (insulation substrate) 121, and implementing a plurality of IC chips 160a-160c for performing drive control of the plurality of first sensor electrodes 11a and the plurality of second sensor electrodes 11b of the sensor section 110 in this disposition region of IC chips.

In this Variation, for example, the IC chip 160b is a driving IC (drive IC) for driving the first and second sensor electrodes 11a and 11b; the IC chip 160a is a controlling IC (controller IC) for controlling the IC chip 160b; and the IC chip 160c is a power source IC for generating a voltage necessary for performing drive control of the sensor electrodes.

In addition, the connection between these IC chips 160a-160c and the peripheral wirings 122a and 122b can be performed by using a nanoparticle paste 163.

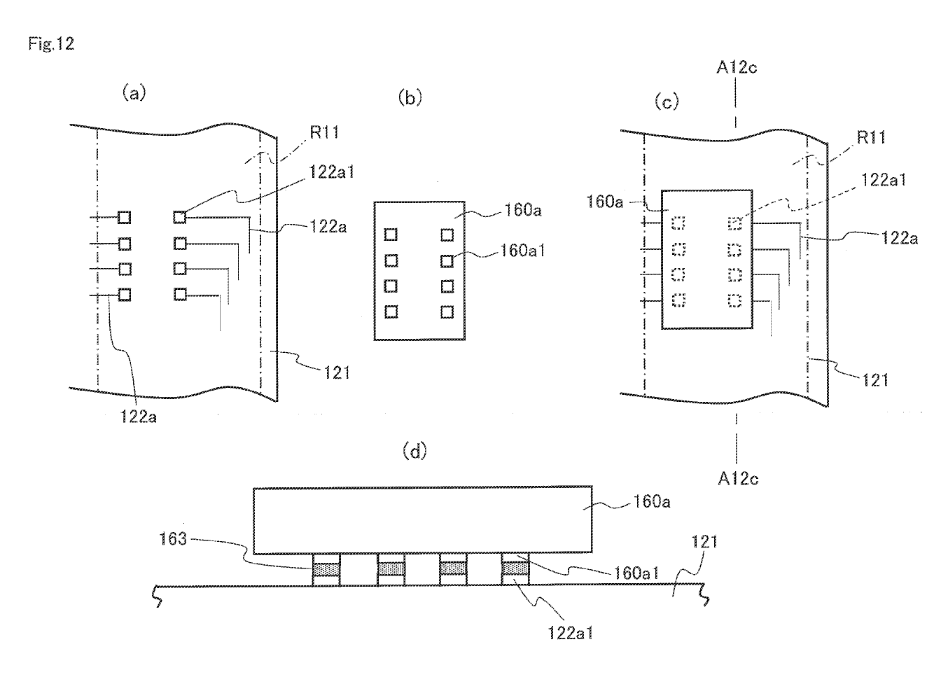

FIG. 12 is a diagram for explaining a connection portion between, for example, the IC chip 160a and the peripheral wirings 122a, wherein FIG. 12(a) shows electrode pads 160a1 of the IC chip 160a; FIG. 12(b) shows connection pads 122a1 of the peripheral wiring section substrate 121; FIG. 12(e) shows a state in which the electrode pads of the IC chip are connected to the connection pads of the peripheral wiring section substrate; and FIG. 12(d) shows a cross-sectional structure at the A12c-A12c portion of FIG. 12(c).

For example, connection pads 122a2 for connecting the peripheral wirings 122a to the electrode pads 160a1 of the IC chip 160a are formed in a region R11 where the IC chip 160 of the peripheral wiring section substrate 121 should be implemented (see FIG. 12(a)).

The connection between the peripheral wirings 122a and the

IC chip 160a can be performed by applying the nano paste 163 to the electrode pads 160a1 formed on the back surface of the IC chip 160a (see FIG. 12(b)), and by bringing the electrode pad 160a1 to which the nanoparticle paste 163 is applied, into contact with the connection pads 122a2 of the peripheral wiring section substrate 122a and burning the nanoparticle paste (see FIG. 12(c) and FIG. 12(d)).

In this manner, in the touch panel module 100c of Variation 3 of Embodiment 1, the controller IC 160a, the drive IC 160b and the power source IC 160c are implemented on the insulation substrate (peripheral wiring section substrate) 121 constituting the peripheral wiring section. Thus, the IC substrate module 140 equipped with the controller IC 140a, the drive IC 140b and the power source IC 140c that was prepared separately from the touch panel module in Variation 1 of Embodiment 1, and the TAB tape 150 equipped with the drive control IC that was prepared separately from the touch panel, module of Variation 2 of Embodiment 1 can be made unnecessary, thereby enhancing a further smaller size and lower cost of a touch panel module.

### Embodiment 2

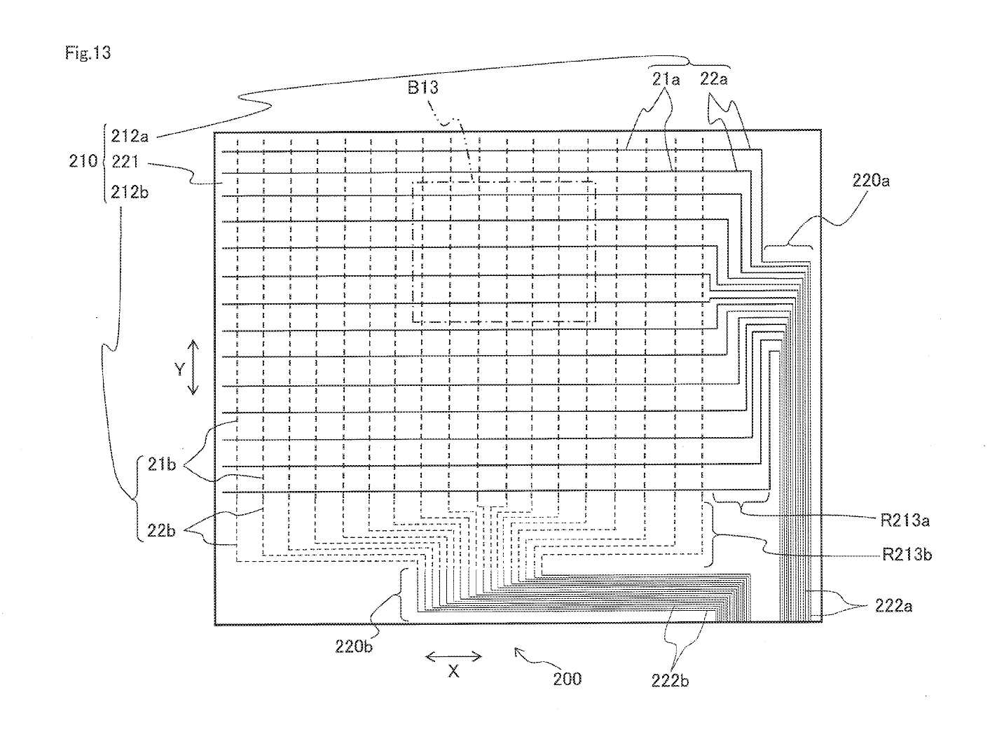

FIG. 13 is a diagram for explaining a touch panel module according to Embodiment 2 of the present invention, which shows the overall structure of this touch panel module.

A touch panel module 200 of this Embodiment 2 comprises a sensor section 210 for detecting an input operation, and peripheral wiring sections 220a and 220b disposed at the periphery of the sensor section 210. The substrates constituting this sensor section 210 and the peripheral wiring sections 220a and 220b are the same insulation substrate 221, and for example, a glass substrate is used for this insulation substrate 221.

In addition, a plurality of sensor section wirings 212a and 212b included in the sensor section 210, and a plurality of peripheral wirings 222a and 222b included in the peripheral wiring sections 220a and 220b are formed at once by a patterning of a metal film made O (depositing metal materials on the insulation substrate 221 by sputtering or vapor deposition. Herein, the line width of the peripheral wirings 222a and 222b is 100 μm-200 μm, and the wiring pitch of the peripheral wirings is 150 μm-500 μm. In this Embodiment 2, for example, the line width of the peripheral wiring is set to 100 μm, and the wiring pitch of the peripheral wirings is set to about 300 μm.

In addition, the plurality of first sensor section wirings 212a are constituted of first sensor electrodes 21a formed on the insulation substrate 221 such that they extend along a X direction (horizontal direction) and first electrode drawing wires 22a that draw these first sensor electrodes 21a to he peripheral edge of the insulation substrate 221, respectively. Further, in the figure, R213a designates a disposition region of the first electrode drawing wires 22a on the insulation substrate 221.

In addition, the plurality of second sensor section wirings 212b are constituted of sensor electrodes 21b formed on the insulation substrate 221 such that they extend along a Y direction (vertical direction), and electrode drawing wires 22b that draw these sensor electrodes 21b to the peripheral edge of the insulation substrate 221, respectively. Further, in the figure, R213b designates a disposition region of the second electrode drawing wires 22b on the insulation substrate 221.

In this Embodiment, metal materials constituting the sensor section wirings 212a and 212b (that is, the sensor electrodes 21a and 21b, and the electrode drawing wires 22a and 22b) are copper. However, the metal materials constituting the sensor section wirings 212a and 212b are not limited to copper, but they may be silver, gold, aluminum or an other low-resistance metal material.

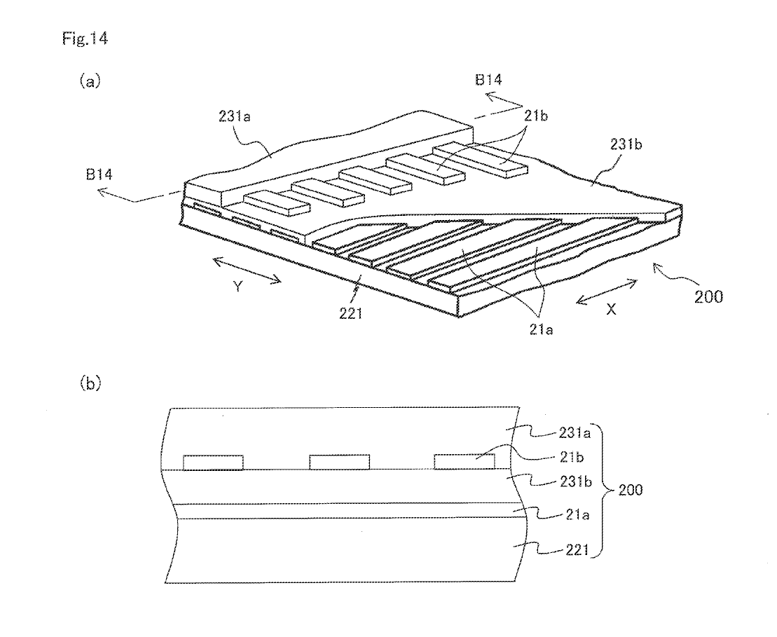

FIG. 14 is a diagram for explaining a touch panel module according to Embodiment 2 of the present invention. FIG. 14(a) is a partially-fractured perspective view showing the enlarged B13 portion of FIG. 13, and FIG. 14(b) is a cross-sectional view of the B14-B14 line portion of FIG. 14(a).

In this touch panel module 200, the plurality of sensor electrodes 21a are formed on the insulation substrate 221 such that they extend in the X direction, and the plurality of sensor electrodes 21b are formed on the plurality of sensor electrodes 21a such that they extend along the Y direction with an insulation layer 231b interposed therebetween. In addition, the plurality of sensor electrodes 21b are covered by an upper-layer insulation layer 231a.

Next, a manufacturing method of the touch panel module of this Embodiment 2 will be explained.

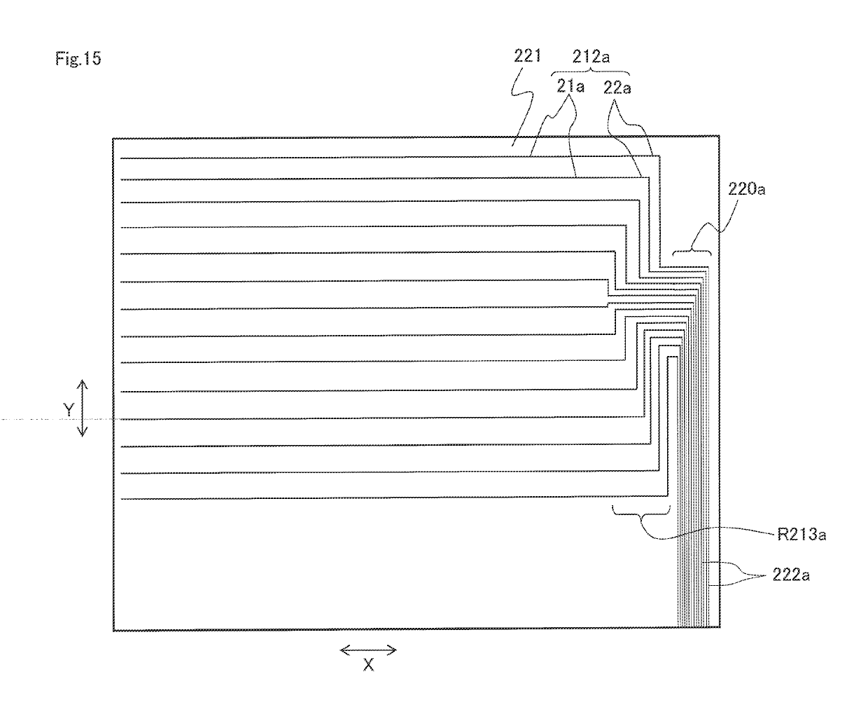

Firstly, a first metal film is formed by depositing Cu on the glass substrate (insulation substrate) 221 by sputtering or vapor deposition, and a patterning of the formed first metal film is performed by a photolithography technique to form the first sensor section wirings 212a (the first sensor electrodes 21a and the first electrode drawing wires 22a) together with the first peripheral wirings 222a linked to these first sensor section wirings 212a at once (see FIG. 15).

Then, after forming the interlayer insulation film 231b on the whole surface, a second metal film is formed by depositing Cu on this insulation film 231b by sputtering or vapor deposition, and a patterning of the formed second metal film is performed by a photolithography technique to form the second sensor section wirings 212b (the second sensor electrodes 21b and the second electrode drawing wires 22b) together with the second peripheral wirings 222b linked to these second sensor section wirings 212b at once (see FIG. 13).

After that, the upper-layer insulation film 231a is formed on the whole surface to complete the touch panel module 200 (see FIG. 14).

In this manner, in the touch panel module 200 according to Embodiment 2 of the present invention, metal films made by depositing conductive materials such as Cu, Ag, Au or Al on the single glass plate 221 by sputtering or vapor deposition, are used for the first and second sensor section wirings 212a and 212b and the first and second peripheral wirings 222a and 222b. Thus, while enhancing low resistance of the sensor section wirings, it is possible to make the wiring width and the wiring pitch of the peripheral wirings narrower compared to the case of using a metal film by plating for the peripheral wirings, and the sensor section wirings and the peripheral wirings can be formed in the same step, thereby al lowing reduction of the manufacturing steps.

In addition, since the first and second sensor section wirings 212a and 212b and the first and second peripheral wirings 222a and 222b are formed by patterning a metal film formed by a thin film forming method (sputtering or vapor deposition) on a glass plate by a photolithography technique, it is possible to perform a fine pattern formation matching a narrow pitch. Thus, in the peripheral wiring section, it is possible to enhance a narrow frame of a touch panel module by narrowing the wiring width and the wiring pitch of the peripheral wirings.

As a result, it is possible to realize a high-performance, low-priced and small-sized touch panel module.

Further, although in the above-described Embodiment 2, the glass substrate 221 is used for an insulation substrate as a foundation member on which the sensor section wirings and the peripheral wirings are formed in the touch panel module 200, a polymeric sheet may be used for an insulation substrate as a foundation member on which the sensor section wirings and the peripheral wirings are formed. However, in this case, such a polymeric sheet is generally adhered to a glass substrate as a support substrate.

### Variation 1 of Embodiment 2

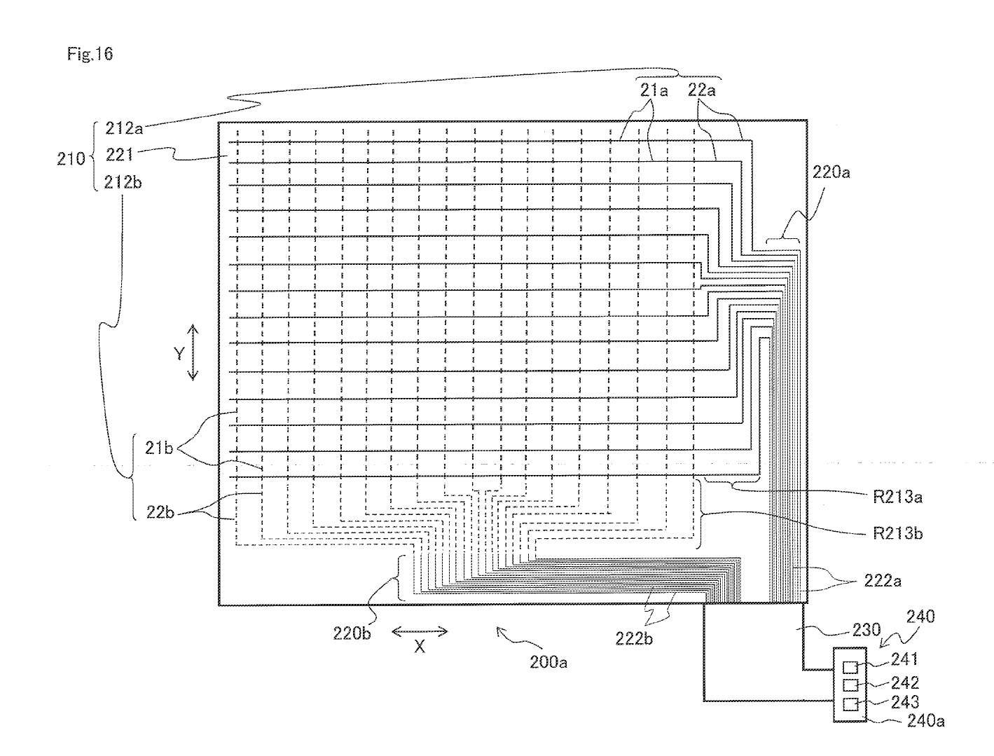

FIG. 16 is a diagram for explaining a touch panel module according to Variation 1 of Embodiment 2 of the present invention, which shows the overall structure of this touch panel module.

A touch panel module 200a according to this Variation 1 of Embodiment 2 is a module obtained by installing a flexible print substrate 230 in the above-described insulation substrate 221 in the touch panel module 200 of Embodiment 2. In the flexible print substrate 230, a plurality of IC chips 241-243 for performing drive control of the plurality of first sensor electrodes 21a and the plurality of second sensor electrodes 21b of the sensor section 210 are implemented.

In this Variation, for example, the IC chip 241 is a driving IC (drive IC) for driving the first and second sensor electrodes 21a and 21b; the IC chip 242 is a controlling IC (controller IC) for controlling the IC chip 241; and the IC chip 243 is a power source IC for generating a voltage necessary for performing drive control of the sensor electrodes.

In addition, as explained using FIG. 8 in Variation 1 of Embodiment 1, the connection between the flexible print substrate 230 and the insulation substrate 221 is performed by joining one end of each of wirings (not shown) of the flexible print substrate 230 with ends of the peripheral wirings 222a and 222b formed on the insulation substrate 221 by using an anisotropic conductive film, a nanoparticle paste or the like. In particular, in this Variation, one end of each of the first and second peripheral wirings 222a and 222b are gathered to a part of the region of the insulation substrate 221 (for example, one corner among the four corners of the insulation substrate), and in this corner, ends of the wirings of one FCC substrate 230 are connected to one end of each of the first and second peripheral wirings 222a and 222b.

In addition, the connection between the flexible print substrate 230 and the IC chips 241-243 is performed by joining electrode terminals of an IC substrate module 240 made by installing the IC chips 241-243 in a print substrate or the like with other ends of the wirings of the flexible print substrate 230 by using an anisotropic conductive film, a nanoparticle paste or the like.

In this Variation 1 of Embodiment 2, one end of each of the first and second peripheral wirings 222a and 222b (ends on the side that is connected with an external circuit) are gathered to a part of the region of the insulation substrate 221 (for example, one corner among the four corners of the insulation substrate), and in this corner, the ends of the wirings of the FPC substrate 230 are connected to the one end of each of the first and second peripheral wirings 222a and 222b. Thus, the FPC substrate 230 installed in the insulation substrate 221 of the touch panel module can be realized by one substrate.

### Variation 2 of Embodiment 2

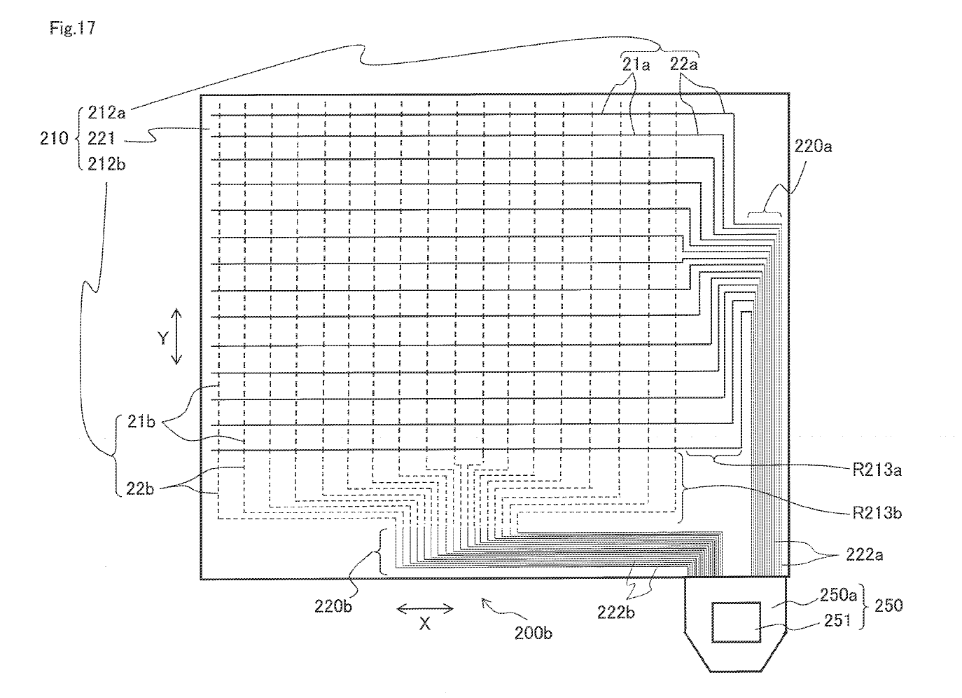

FIG. 17 is a diagram for explaining a touch panel module according to Variation 2 of Embodiment 2 of the present invention, which shows the overall structure of this touch panel module.

A touch panel module 200b according to this Variation 2 of Embodiment 2 is a module obtained by installing a TAB tape 250 in the above-described insulation substrate 221 in the touch panel module 200 of Embodiment 2. This TAB tape 250 is made by equipping a tape member 250a with a drive control IC 251 for performing drive control of the plurality of first sensor electrodes 21a and the plurality of second sensor electrodes 21b of the above-described sensor section 210, by a tape-automated bonding.

In addition, as explained using 10 in Variation 2 of Embodiment 1, the connection between the TAB tape 250 and the insulation substrate 221 is performed by joining one end of each of wirings (not shown) of the TAB tape 250 with ends of the peripheral wirings 222a and 222b formed on the insulation substrate 221 by using an anisotropic conductive film, a nanoparticle paste or the like. In particular, in this Variation, one end of each of the first and second peripheral wirings 222a and 222b are gathered to a part of the region of the insulation substrate 221 (for example, one corner among the four corners of the insulation on substrate), and in this corner, ends of the wirings of one TAB tape 250 are connected to one end of each of the first and second peripheral wirings 222a and 222b.

Also in Variation 2 of Embodiment 2 having such a configuration, as in the case of Variation 1 of Embodiment 2, one end of each of the first and second peripheral wirings 222a and 222b (ends on the side that is connected with an external circuit) are gathered to a part of the region of the insulation substrate 221 (for example, one corner among the four corners of the insulation substrate), and in this corner, connection pads (not shown) of wirings of the TAB tape 250 are connected to one end of each of the first and second peripheral wirings 222a and 222b. Thus, the TAB tape 250 installed in the insulation substrate 221 of the touch panel module can be realized by one tape.

### Variation 3 of Embodiment 2

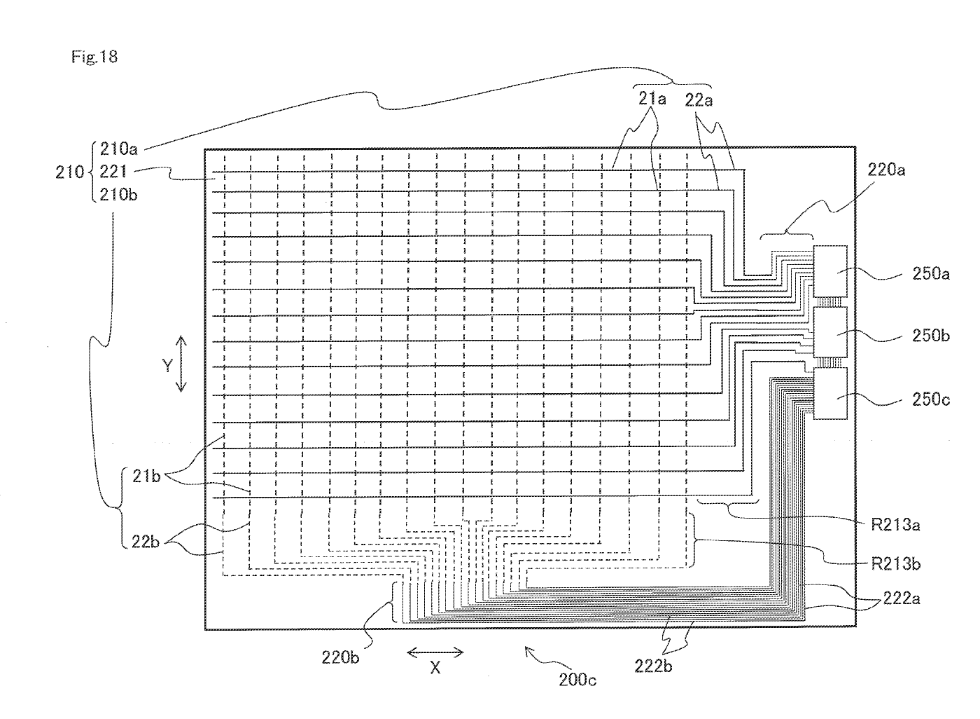

FIG. 18 is a diagram for explaining a touch panel module according to Variation 3 of Embodiment 2 of the present invention, which shows the overall structure of this touch panel module.

A touch panel module 200e of this Variation 3 of Embodiment 2 is a module obtained by implementing a plurality of IC chips 260a-260c in a region on the external side of the peripheral wiring section 220a on the above-described insulation substrate 221 in the touch panel module 200 of Embodiment 2. The plurality of IC chips 260a-260c perform drive control of the plurality of first sensor electrodes 21a and the plurality of second sensor electrodes 21b of the sensor section 210.

In this Variation, for example, the IC chip 260b is a driving IC for driving the first and second sensor electrodes 21a and 21b; the IC chip 260a is a controlling IC for controlling the IC chip 260b; and the IC chip 260c is a power source IC for generating a voltage necessary for performing drive control of the sensor electrodes.

In addition, as explained using FIG. 12 in Variation 3 of Embodiment 1, these IC chips 260a-260c and the peripheral wirings 222a and 222b are joined by using a nanoparticle paste.

In this manner, in the touch panel module 200c of Variation 3 of Embodiment 2, the controller IC 160a, the drive IC 160b and the power source IC 1600 are implemented on the insulation substrate (peripheral wiring section substrate) 221 constituting the peripheral wiring section. Thus, the IC substrate module 240 equipped with the controller IC 240a, the drive IC 240b and the power source IC 240c that was manufactured separately from the touch panel module in Variation 1 of Embodiment 2, and the TAB tape 250 equipped with the drive control IC that was manufactured separately from the touch panel module of Variation 2 of Embodiment 2 can be made unnecessary, thereby enhancing a further smaller size and lower cost of a touch panel module.

### Embodiment 3

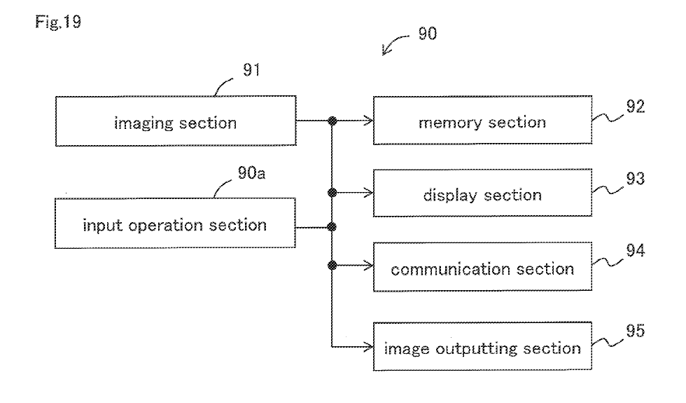

FIG. 19 is a block diagram showing a schematic configuration example of an electronic information equipment using a touch panel module according to any of Embodiment 1, and Variations 1-3 thereof; and Embodiment 2, and Variations 1-3 thereof, for an input operation section, as Embodiment 3 of the present invention.

An electronic information equipment 90 according to Embodiment 3 of the present invention shown in FIG. 19 comprises a touch panel module according to at least one of Embodiment 1, and Variations 1-3 thereof; and Embodiment 2, and Variations 1-3 thereof, of the present invention as an input operation section 90a for performing an information input by an operator. This electronic information equipment 90 has at least one of a memory section 92 such as a recording medium for recording input information input from the input operation section 90a, a display section 93 such as a liquid crystal display device for displaying this input information on a display screen such as a liquid crystal display screen, a communication section 94 such as a transceiver device for processing communication using this input information, and an image outputting section 95 for printing (printing as characters) and outputting (printing out) this input information. Herein, the display section 93 comprises a display device such as a liquid crystal display panel which is combined with the above-described input device. Further, this electronic information equipment 90 may have an imaging section 91 for capturing an object. In this case, the electronic information equipment 90 may be configured such that the memory section 92 such as a recording medium records data after predetermined signal processing for recording image data obtained by the imaging section 91, and the above-described display section 93 displays the image data on a display screen such as a liquid crystal display screen after predetermined signal processing for display, and the communication section 94 performs communication processing of the image data after the image data undergoes predetermined signal processing for communication, and the image outputting section 95 prints (print as characters) and outputs (prints out) the image data.

As described above, the present invention is exemplified by the use of its preferred Embodiments of the present invention. However, the present invention should not be interpreted solely based on the Embodiments. It is understood that the scope of the present invention should be interpreted solely based on the scope of the claims. It is also understood that those skilled in the art can implement equivalent scope of technology, based on the description of the present invention and common knowledge from the description of the detailed preferred Embodiments of the present invention. Furthermore, it is understood that any patent, any patent application and any references cited in the present specification should be incorporated by reference in the present specification in the same manner as the contents that are specifically described therein,

### INDUSTRIAL APPLICABILITY

In the present invention, in the fields of touch panel modules and electronic information equipment, it is possible to realize a touch panel module, which can speed up reaction speed for an input operation, lower current consumption, and suppress generation of heat in a sensor electrode by reducing the resistance of the sensor electrode, and as a result, improves responsiveness to d touch operation by speeding up reaction speed for an input operation, also alleviates restriction of operating time in battery-powered equipment by reduction of current consumption, and further reduces influence of heat on other equipment by suppression, of heat generation in the sensor electrode, and to realize an electronic information equipment equipped, with such a touch panel module,

### REFERENCE NUMERAL LIST

11a, 21a first sensor electrode
11b, 21b second sensor electrode
12a, 22a first electrode drawing wire
12b, 22b second electrode drawing wire
12a1 one end of the first electrode drawing wire
90 electronic information equipment
90a input operation section
91 imaging section
92 memory section
93 display section
94 communication section
95 image outputting section
100, 100a-100c, 200, 200a-200c touch panel module
103 anisotropic conductive film
110, 210 sensor section
110a, 110b first and second sensor sheets
111 sensor section substrate
111a, 111b) first and second insulation sheet members
112a, 212b first, sensor section wiring
112b, 212b second sensor section wiring
120a, 220a first peripheral wiring section
120b, 220b second peripheral wiring section
121 glass substrate (peripheral wiring section substrate)
122a, 222a first peripheral wiring
122b, 222b second peripheral wiring
122a1 one end of first peripheral wiring
122a2 connection pad
130, 230 flexible print substrate
140 IC substrate module
140a print substrate
141, 241 controller IC (IC chip)
142, 242 drive IC (IC chip)
143, 243 power source IC (IC chip)
150, 250 TAB tape
150a, 250a tape member
151, 251 drive control IC
160a-160c, 260a-260c IC chip
160a1 electrode pad
163 nano paste
221 insulation substrate
231a upper-layer insulation film
231b interlayer insulation film
R113a, R213a first peripheral wiring disposition region
R113b, R213b second peripheral wiring disposition region

1. A touch panel module comprising a sensor section for detecting an input operation, and a peripheral wiring section disposed at the periphery of the sensor section, wherein
a sensor section substrate constituting the sensor section and a peripheral wiring section substrate constituting the peripheral wiring section are separate substrates,
a plurality of sensor section wirings included in the sensor section are of a metal film having lower resistance compared to a conductive film constituting a plurality of peripheral wirings included in the peripheral wiring section, and
the conductive film constituting the peripheral wiring is a transparent conductive film having a smaller minimum processing pattern width and a smaller minimum processing pattern pitch compared to the metal film constituting the sensor section wirings.

2. The touch panel module of claim 1, wherein the plurality of sensor section wirings comprise
a plurality of electrodes formed on the sensor section substrate, for detecting the input operation, and
a plurality of electrode drawing wires formed on the sensor section substrate, which draw the plurality of electrodes up to a peripheral edge section of the sensor section substrate,
wherein the sensor section substrate is overlapped and disposed on the peripheral wiring section substrate such that one end of each of the electrode drawing wires and one end of each of the peripheral wirings oppose each other, and the opposing one end of each of the electrode drawing wires and one end of each of the peripheral wirings are joined by a nanoparticle material or an anisotropic conductive film.

3. The touch panel module of claim 2, wherein the peripheral wiring section substrate is installed with a flexible print substrate in which IC chips for performing drive control of the plurality of electrodes of the sensor section are implemented.

4. The touch panel module of claim 2, wherein IC chips for performing drive control of the plurality of electrodes of the sensor section are implemented on the peripheral wiring section substrate.

5. An electronic information equipment having an image display section for displaying an image, and an information input section disposed on a display screen of the image display section, for inputting information, wherein the information input section comprises the touch panel module of claim 1.
